(19) United States
(12) Patent Application Publication
(10) Pub. No.: US 2002/0116342 A1
(43) Pub. Date: Aug. 22, 2002

(54) Domestic electrical apparatus, subscriber registering method, order receiving method, and data processing system

(76) Inventors: Yasuhiro Hirano, Hachioji (JP); Takayuki Kawahara, Higashiyamato (JP); Hiroyasu Ohtsubo, Yokohama (JP); Koji Sakamoto, Hachioji (JP); Masutomi Ohta, Yokohama (JP); Hiroshi Hatae, Toda (JP); Kei Suzuki, Kokubunji (JP)

Correspondence Address: Mattingly, Stanger & Malur, P.C, 104 East Hume Avenue, Alexandria, VA, 22301, US

(21) Appl. No.: 10/042,160

(22) Filed: Jan. 11, 2002

(30) Foreign Application Priority Data
Feb. 20, 2001 (JP) 2001-043211

(51) Int. Cl. G06F 17/60

(52) U.S. Cl. 705/64

(57) ABSTRACT

A data processing system used for a net-order sale or the like includes a host apparatus connectable to a terminal apparatus via a network. The host apparatus includes a database in which cryptographic keys are registered in being caused to correspond to user IDs. The cryptographic keys are caused to be related in a one-to-one manner to appliance manufacture numbers of domestic electrical apparatuses onto which terminal apparatuses are integrated. The host apparatus retrieves, from the database, a cryptographic key corresponding to a user ID that accompanies a transaction request from the terminal apparatus. Using the retrieved cryptographic key, the host apparatus performs encryption/decryption processings of information data transmitted/received between the terminal apparatus and the host apparatus. Information having a one-to-one correspondence relationship with the appliance manufacture number of the domestic electrical apparatus is utilized as the whole of the cryptographic key.

### BACKGROUND OF THE INVENTION

The present invention relates to a domestic electrical apparatus (home electric appliance) implemented in consideration of being connected to a network, a subscriber registering method into the network, an order receiving method via the network, and a data processing system designed for a commodity/service sale that utilizes the network. More particularly, it relates to technologies that are effective when applied to an electronic transaction system or service for implementing a local-community closely-contacted type net-order sale via, for example, an equipment-based home network.

In recent years, in accompaniment with the rapid increase in the Internet utilizing population, attention has been focused on the business of the commodity/service sale that utilizes such networks as the Internet (i.e., the net-order sale). As a result, the trials of the various types of services are now being carried out.

Meanwhile, the equipment-based home network where the power line or the like is used as the transmission medium is now being developed as an intra-home communications infrastructure. In Japan, Echonet Consortium is promoting the development and standardization of a practical and easy-to-use system referred to as “Echonet” where the power line or a power-saved wireless is used as the transmission medium. This Echonet makes it possible to receive the energy management for allowing energy-saving to be implemented without damaging comfortableness, and also to receive the security, the health care, and the silver support linked and associated closely with a social system through the connection to a wide area network. In the United States, HomePlug Powerline Alliance is promoting the development and standardization of a home networking technology where the power line is used as the transmission medium.

From this time on, the above-described equipment-based home network is expected to become prevalent as the intra-home communications infrastructure that is harmonized with humans and the environment and that provides safety, comfortableness, and convenience. Moreover, as is the case with the conventional Internet-utilizing net-order sale, the examination of the commodity/service sale that utilizes the equipment-based home network is now being promoted.

As a technology for providing the equipment-based-home-network-utilizing service, there exists the one disclosed in JP-A-10-341289. This technology includes a first domestic electrical apparatus having a memory unit for storing an appliance/type specific number and a failure location, and a television set (i.e., gateway) having a receptacle into which a power-supply plug of the first domestic electrical apparatus can be plugged and being connected to the service center via the telephone line. Here, the plug of the first domestic electrical apparatus is plugged into the receptacle of the television set, thereby constructing a power line carrier system. This system is capable of sending to the service center the information such as the specific number and the failure location of the first domestic electrical apparatus, thereby making it possible to request the provision of the service thereto. In the commodity/service sale that utilizes the Internet, the Echonet, and so on, from the viewpoint of security, it is absolutely necessary to encrypt the transaction information. This condition requires that a service providing side and a service requesting source (i.e., user) share the cryptographic key. Conventionally, in general, the user has determined and set such a common cryptographic key under the limitations of the characters' number or the like. However, to a user who is not accustomed to the operation of such electronic appliances as the network appliances, such an operation is a task of extreme difficulty. Accordingly, it is anticipated that the user may employ, as the cryptographic key, a numeral string that is too simple. Also, it is apprehended that the user may forget a common cryptographic key once set and thus may bring about a situation where the network cannot be utilized ever again.

Also, in the prior-art net-order sale service via the equipment-based home network, it is difficult to avoid the following problems. That is, the operation is complicated, which has become a problem in the Internet utilizing net-order sale service, and the response waiting time is long, and so on. Also, concerning the settlement using electronic money or the like, the user feels a sense of uneasiness about the security and the safety thereof. On account of this, expectations are concentrated on the implementation of a net-order sale system that exhibits a simple-operability, a high-safety, and a good-consistency with the equipment-based home network.

### SUMMARY OF THE INVENTION

It is an object of the present invention to provide a technology for facilitating the setting and the management of a cryptographic key needed when a domestic electrical apparatus or the like is made applicable to a terminal apparatus of an electronic transaction service.

It is another object of the present invention to provide a technology for making it possible to enhance safety and convenience in the electronic transaction when the domestic electrical apparatus or the like is made applicable to the terminal apparatus of the electronic transaction service.

It is still another object of the present invention to provide a technology for allowing, using the domestic electrical apparatus or the like, the implementation of a high added-value of being able to be closely linked and associated with a social system through the connection to a wide area network or the like.

An even further object of the present invention is as follows. Attention is focused on the characteristics of the equipment-based home network, e.g., no wiring required, simple application development, the plug-and-play function, and the wide-area-network connection, thereby providing technologies concerning the domestic electrical apparatus, a data processing system, an order receiving method, and the like which allow the implementation of an electronic transaction service intended for a local-community closely-contacted type outstanding-convenience/safety net-order sale or the like.

The above-described and the other objects of the present invention and the novel features thereof will be clearly understood from the description in the present specification and the accompanying drawings.

(1) Of the inventions that will be disclosed in the present application, the general outline of the representative invention will be explained below as a whole.

A controller unit needed for controlling the operation/function of the equipment-based home network system is also utilized as the terminal apparatus of the net-order sale service. Moreover, in the net-order sale service where the equipment-based home network system and a wide area network system are connected to each other, the transmission/reception is performed using the data that has been subjected to an encryption processing. A cryptographic key needed for this encryption processing had been already registered (i.e., the cryptographic key had been already set into the encryption processing circuit in the controller unit) in a one-to-one correspondence with an appliance number (e.g., an appliance manufacture number) at the time of the product's shipment. From a point-in-time when a subscriber subscribed to the net-order sale service, the transmission/reception is performed regarding the data that has been encryption-processed using this cryptographic key. In short, a service providing dealer, using-the appliance number of the subscriber, acquires the cryptographic key that is in the one-to-one correspondence with the appliance number. Furthermore, the subscriber and the service providing dealer perform the encryption processing with this cryptographic key used as the common key. The cryptographic keys set for the respective subscribers all differ from each other. Eventually, this technological method makes it possible to construct the electronic transaction service or the like based on the outstanding-security/safety net-order sale system.

Incidentally, taking into consideration the conditions such as being current-carrying all night, a wide setting-up space, and a large number of access times, it is preferable that the controller unit as the terminal apparatus be integrally set up onto, e.g., a refrigerator which is a domestic electrical apparatus. In addition to the refrigerator, the domestic electrical apparatus refers to an air conditioner, a microwave oven, a washing machine, a dryer, a vacuum cleaner, an illuminating appliance, and so on.

In order to try to enhance the safety/convenience, the following technological methods are employed further. \mathring{1} The fingerprints, the voiceprint, or the like of a user who will utilize the electronic transaction service are registered in advance, and the service utilization is limited to the registered user alone. \mathring{2} The user sets an upper-limit of the purchase money-amount, the purchase quantity, or the like in the electronic transaction service, and the service utilization is limited to the case smaller than the upper-limit. \mathring{3} The connection to the electronic transaction service is performed by a one-touch operation of the corresponding button of the terminal apparatus, or by an automatic connection based on voice recognition.

Meanwhile, on the net-order sale service providing side, the following technological methods are employed. \mathring{1} There is equipped a function of studying the purchase information on the subscriber, thereby providing, with a high-priority, the information that is to the subscriber's taste. \mathring{2} In order to shorten a response waiting time at the time of the service provision, commodity information or the like is downloaded onto the terminal apparatus in advance. Also, using memory cards or the like, catalogue information or the like is distributed in advance.

The above-described technological methods make it possible to construct, via the equipment-based home network, the electronic transaction service based on a more outstanding-safety/convenience net-order sale system.

Furthermore, in the present invention, a prepaid (credit) card settlement system is employed. Then, at the time of the purchase, the user causes a prepaid card to memorize information on an ordered commodity, the money-amount to be paid, or the like. At the time of receiving the commodity, the user makes a payment of the price by the prepaid card only when the commodity and the money-amount recorded in the prepaid card coincide with the actually received commodity and the money-amount thereof. As a consequence, in comparison with the settlement using the conventional electronic money, it is possible to implement a higher-safety settlement system.

Also, maintenance/failure service, medical care/nursing service, and comfortable life supporting service are linked with the net-order sale service providing side. This makes it possible to easily implement the wide-area-network connection, i.e., the characteristic of the equipment-based home network.

As having been described so far, the technological methods in the present invention allow the implementation of the electronic transaction system that can be positioned as a local-community closely-contacted type outstanding-safety/convenience electronic order-taker.

(2) Next, the present invention will be explained below on each concrete aspect basis.

<<Domestic Electrical Apparatus>>

A domestic electrical apparatus in the present invention includes the controller unit having a communication unit with the outside, an operating unit, and a data processing unit. The controller unit includes a cryptographic processing unit that utilizes the information as a part or the whole of the cryptographic key for information communications performed by the communication unit, the information having the one-to-one correspondence relationship with the appliance number specific to the domestic electrical apparatus.

The information having the one-to-one correspondence relationship with the appliance number of the domestic electrical apparatus is utilized as the part or the whole of the cryptographic key. Accordingly, it becomes possible to facilitate the setting and the management of the cryptographic key needed when the controller unit set up in the domestic electrical apparatus is made applicable to the terminal apparatus of the net-order sale system or the like.

When converting information data to be sent into the encrypted data and decrypting received information data back to the information data, the cryptographic processing unit uses the cryptographic key as described above. This makes it possible to maintain the security of the information transmitted on the network.

If the appliance number is utilized as the part of the cryptographic key, the remainder of the cryptographic key is assumed to be information that has a one-to-one correspondence relationship with code information for specifying the manufacturing maker of the domestic electrical apparatus. Consequently, even if there exists an overlap in the appliance numbers between domestic electrical apparatus makers, it becomes possible to easily implement the differentiation therebetween.

The communication unit is connectable to the service providing parties on the wide area network. When, for example, utilizing the Echonet as the equipment-based home network where the power carrier line is used as the transmission medium, the communication unit is connectable to the Echonet implemented for the power line carrier communications. The data processing unit can control the connection to the service providing parties on the wide area network from the Echonet via a gateway. In the connection to the wide area network, the data processing unit can control to transmit the provision of a service along with the user ID to the service providing parties on the wide area network via the communication unit, the service being specified by an operation performed by the operating unit. The connection with the wide area network is not limited to the communications via the home network.

Considering that the connection to the wide area network is guaranteed, it is preferable that the controller unit include an authenticating unit for executing the authentication of an operating party for the operating unit within the home network. A single ID has been assigned to the domestic electrical apparatus into which the specific cryptographic key had been set, and in addition, the valid user is registered beforehand using the fingerprints, the voiceprint, or the like. This registration allows the service utilization via the network to be limited to the registered valid user, thereby making it possible to maintain the safety of the system.

In order to enhance the operability or the convenience in the case of requesting the service provision to the service providing parties on the wide area network, the following configuration is allowable. The controller unit stores information for supporting the operation by the operating unit of requesting the service provision, and includes a database made accessible from the data processing unit, and is caused to configure a virtual WWW server using the information stored in the database.

In order to further enhance the added-value of the domestic electrical apparatus having the connecting function to the wide area network, it is preferable that the controller unit include an energy-saving processing unit for controlling the domestic electrical apparatus into a working state that is suitable for its set-up environment. Also, it is preferable that the controller unit include a life-reaction processing unit. The life-reaction processing unit detects the presence or absence of a life-reaction on the basis of an interval between operations toward the domestic electrical apparatus, and is capable of making an abnormality report via the communication unit on the basis of a judgement that there exists no life-reaction. Also, the controller unit may include a failure detection processing unit that is capable of making a failure report via the communications unit when the domestic electrical apparatus has been judged to fail. The data processing unit may include a controlling function for selecting a superior service providing party by considering the price-to-service ratio with respect to the service specified from the operating unit. Moreover, the operating unit may perform the transmission/reception of the information with the data processing unit via a power-saved wireless or infrared ray.

<<Subscriber Registering Method>>

A method of registering, as a service requester, a purchaser of the domestic electrical apparatus into the computer apparatus of a service provider for providing a predetermined service to the purchaser includes the following processings. A processing of inputting an appliance number specific to the domestic electrical apparatus that the purchaser has purchased, a processing of acquiring a cryptographic key that has a one-to-one correspondence relationship with the inputted appliance number, and a processing of registering the acquired cryptographic key as one of subscriber information on the service requester. Here, in performing the service provision to the subscriber, information to be provided to the subscriber is encrypted using the cryptographic key, and information provided from the subscriber is decrypted using the cryptographic key. This subscriber registering method makes it possible to establish a technique for subscriber-registering the purchaser of the domestic electrical apparatus or the like into a predetermined service network.

The above-described processing of acquiring the cryptographic key can be defined as a processing of presenting the appliance number to the computer apparatus that the manufacturing maker of the domestic electrical apparatus manages, and of receiving the cryptographic key returned in response to the appliance number presented.

<<Order Receiving Method>>

An order receiving method by which a host apparatus connected to a terminal apparatus via a network receives an order from the terminal apparatus includes the following processings. A processing of making reference to a database in which cryptographic keys have been registered in being caused to correspond to user IDs, the cryptographic keys being caused to be related in a one-to-one manner to appliance numbers specific to domestic electrical apparatus onto which terminal apparatuses have been integrated, and of retrieving a cryptographic key corresponding to the user ID from the terminal apparatus, a processing of decrypting, using the retrieved cryptographic key, the order data from the terminal apparatus so as to receive the order, and a processing of encrypting, using the retrieved cryptographic key, confirmation data for confirming the received order. This makes it possible to establish the order receiving method that uses a cryptographic key corresponding to an appliance number.

In order to ensure the safety in the transaction in points of the payment ability or the like, it is preferable to perform a processing of setting an upper-limit of the price for the order from the terminal apparatus, and of limiting the reception of the order up to the upper-limit.

Also, so as to fulfill the order-received contents for the ordering source, the host apparatus may perform a processing of sending the order-reception information to a dealing party for performing the dispatch of an order-received commodity or the fulfillment of an order-received service.

In order to perform the settlement of the price toward the ordering source, the host apparatus may perform a processing of sending the order-reception information to a settlement institution for settling the price for an order-received order.

In order to smooth the order receiving processing on the network, it is preferable that the host apparatus provide in advance order-receivable contents to a plurality of terminal apparatuses as a transaction guide. Assuming that the connection to the Internet has been made, the transaction guide may be hyper-media information for configuring the virtual WEB server in the terminal apparatuses.

Also, in order to smooth the order receiving processing on the network from another viewpoint, the host apparatus may perform a processing of studying the order-received contents on each user ID basis, and of providing order-receivable transaction contents, which satisfy a taste predicted from the study result, to the terminal apparatus of the user ID as a transaction guide.

<<Data Processing System>>

In the case of grasping the above-described transaction technique via the network from the viewpoint of a data processing system, the data processing system has a host apparatus that is connectable to a terminal apparatus via the network. The host apparatus has a database in which cryptographic keys have been registered in being caused to correspond to user IDs, the cryptographic keys being caused to be related in a one-to-one manner to appliance numbers specific to domestic electrical apparatus onto which terminal apparatuses have been integrated. Moreover, the host apparatus, from the database, retrieves a cryptographic key corresponding to the user ID that accompanies a transaction request from the terminal apparatus. Furthermore, using the retrieved cryptographic key, the host apparatus decrypts information data sent from the terminal apparatus, and encrypts information data to be sent to the terminal apparatus, thus receiving the transaction request from the terminal apparatus.

The data processing system may further has a fulfillment side terminal apparatus for inputting the transaction request contents so as to cause the contents to be fulfilled, the transaction request contents having been received from the terminal apparatus by the host apparatus. Also, the data processing system may further has a price-settlement side terminal apparatus for inputting the transaction request contents so as to cause the price for the request to be settled, the transaction request contents having been received from the terminal apparatus by the host apparatus.

### BRIEF DESCRIPTION OF THE DRAWINGS

FIG. 1 is a block diagram for illustrating the basic configuration of a system for implementing an electronic order-taking service;

FIG. 2 is a flow chart for illustrating the processing steps of a subscriber registration;

FIGS. 3A and 3B are explanatory diagrams for illustrating the one-to-one correspondence relationship between an appliance manufacture number and a cryptographic key;

FIGS. 4A and 4B are flow charts for illustrating one example of an encryption and decryption processings using the cryptographic key;

FIG. 5 is a block diagram for illustrating one detailed embodiment of an terminal apparatus;

FIG. 6 is a block diagram for illustrating a terminal apparatus resulting from adding a user registration authenticating unit to the terminal apparatus in FIG. 5;

FIG. 7 is a block diagram for illustrating a terminal apparatus resulting from adding a service limitation processing unit to the terminal apparatus in FIG. 5;

FIG. 8 is a block diagram for illustrating a terminal apparatus resulting from adding an energy-saving processing unit to the terminal apparatus in FIG. 5;

FIG. 9 is a block diagram for illustrating a terminal apparatus resulting from adding a life-reaction processing unit to the terminal apparatus in FIG. 5;

FIG. 10 is a block diagram for illustrating an embodiment where the terminal apparatus including the life-reaction detecting function explained in FIG. 9 is applied to a refrigerator;

FIG. 11 is a block diagram for illustrating the details of the life-reaction reporting function by the life-reaction detecting unit in FIG. 10;

FIG. 12 is a block diagram for illustrating the details of the failure automatic reporting function by the failure automatic detecting unit in FIG. 10;

FIG. 13 is a perspective view for illustrating the outside appearance of the refrigerator onto which the terminal apparatus has been integrated;

FIG. 14 is a flow chart for illustrating the operating steps of an ASP service such as an electronic order-taker by the terminal apparatus;

FIG. 15 is an explanatory diagram for illustrating displayed examples of the display pictures provided by the ASP service;

FIG. 16 is a block diagram for illustrating one detailed embodiment of an ASP;

FIG. 17 is a block diagram for illustrating the details of an ASP resulting from adding a client-taste studying function unit to the ASP in FIG. 16;

FIG. 18 is an explanatory diagram for illustrating one example of the service by the client-taste studying function;

FIG. 19 is a block diagram for illustrating still another embodiment of the ASP where attention has been focused on the client-taste studying function unit;

FIG. 20 is an explanatory diagram for illustrating an advertisement picture created by an advertisement creation processing unit;

FIG. 21 is an explanatory diagram for illustrating one embodiment of the transaction form using the electronic order-taking service system;

FIG. 22 is an explanatory diagram for illustrating a settlement technique in the transaction using the electronic order-taking service system;

FIG. 23 is an explanatory diagram for illustrating a simple settlement technique in the transaction using the electronic order-taking service system;

FIG. 24 is an explanatory diagram for illustrating a transaction form where partnership service dealers are added to the provision of the service using the electronic order-taking service system;

FIG. 25 is an explanatory diagram for illustrating a transaction form where an Internet connecting service is added to the service provision in FIG. 24 using the electronic order-taking service system;

FIG. 26 is a block diagram for illustrating an embodiment of the terminal apparatus that performs the transmission/reception of data between an input/display unit and the main body of the terminal apparatus via a wireless communication system;

FIG. 27 is a block diagram for illustrating an embodiment of the terminal apparatus that performs the transmission/reception of the data between the input/display unit and the main body of the terminal apparatus via an infrared-ray communication system;

FIG. 28 is a block diagram for illustrating an embodiment of a terminal apparatus to which an AI function unit is added; and

FIG. 29 is a block diagram for illustrating a system embodiment that is connected to an AV-based home network as well.

### DETAILED DESCRIPTION OF THE EMBODIMENTS

The domestic electrical apparatus, the order receiving method, or the like according to the present invention will be explained in detail in such a manner as to be applied to the electronic transaction (e.g., commissioning, ordering, and order-taking) service. The electronic transaction is also referred to as simply “electronic order-taker”.

<<Outline of Electronic Order Service System>>

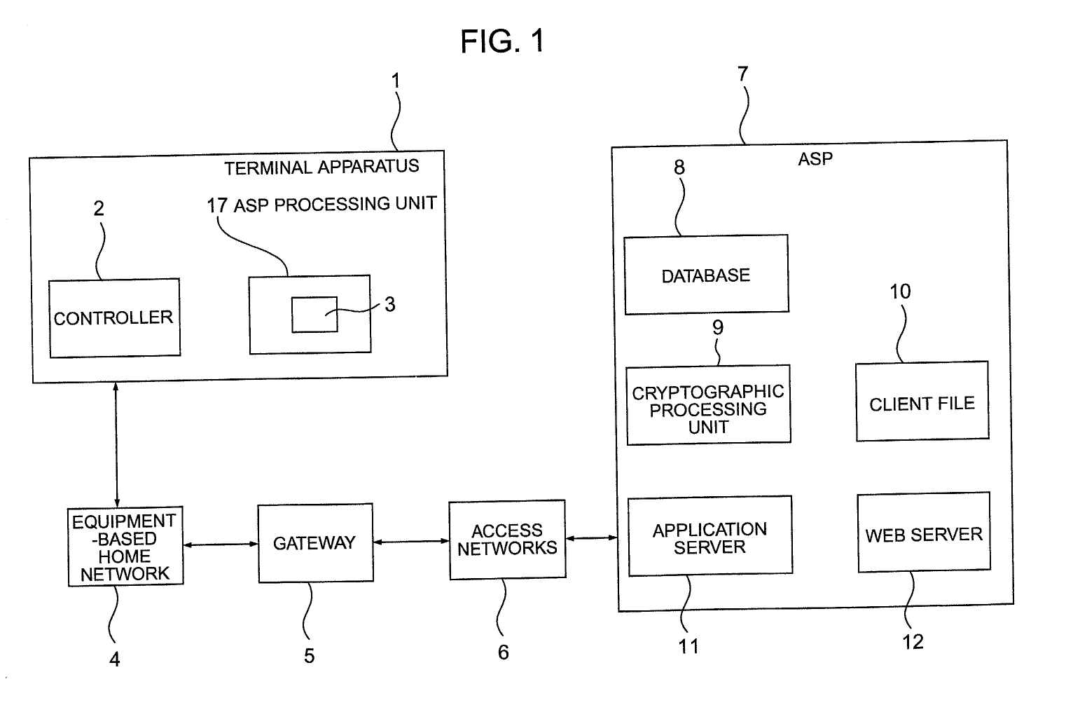

FIG. 1 illustrates the system basic configuration for implementing the electronic order-taking service. The system for the electronic order-taking service (i.e., the electronic order-taking service system) illustrated in the same drawing has an ASP (i.e., Application Service Provider) 7 as a host apparatus on the service providing side, and includes a terminal apparatus 1 indicated representatively on the service ordering side.

The terminal apparatus 1 is connected to an Echonet 4 as an equipment-based home network. The Echonet 4 is connected via a gateway 5 to access networks 6 as wide area networks such as the public line network and the Internet. Regarding the home network configuration including the gateway 5, the Echonet 4, and the terminal apparatus 1 which are connected to the access networks 6, it turns out that, actually, plural sets of the configurations are located. Although not particularly specified, the equipment-based home network 4 is the Echonet whose development and standardization Echonet Consortium is now promoting.

The terminal apparatus 1 can be positioned as a controller unit mounted in a domestic electrical apparatus such as a refrigerator. The terminal apparatus 1 includes a controller 2 for controlling the operation/function of the Echonet as the equipment-based home network, and an ASP processing unit 17 for performing data communications with the ASP (i.e., Application Service Provider) 7 on the electronic order-taking service providing side. Here, since the ASP processing unit 17 performs the communications with the service providing side ASP 7 by encrypted data, the unit 17 has at least a data encryption processing function (i.e., a cryptographic processing unit 3). In the cryptographic processing unit 3, a cryptographic key that had been caused to correspond in a one-to-one manner to the appliance number of the domestic electrical apparatus at the time of the product's shipment lies in a state of having been already set and registered, and the unit 3 performs a predetermined encryption processing based on this cryptographic key. For example, the unit 3 performs the following processing. Converting information data to be sent from the terminal apparatus 1 (e.g., service ordering information) into encrypted data by the cryptographic key, and decrypting data received at the terminal apparatus 1 (e.g., confirmation data such as a proof regarding the order) back to the information data by the cryptographic key.

The ASP 7 has a database 8, a cryptographic processing unit 9, a client file 10, an application server 11, a WEB server 12, and the like. At the time of a subscriber registration into the service system, based on the appliance number of the domestic electrical apparatus of the subscriber, this ASP 7 acquires the cryptographic key that has been already set and registered into the domestic electrical apparatus on the subscriber side. The acquired cryptographic key is registered into the client file 10 as one of subscriber information of the service requester. In performing the service provision to the subscriber, the cryptographic processing unit 9, using the cryptographic key, encrypts information to be provided to the subscriber and decrypts information provided from the subscriber.

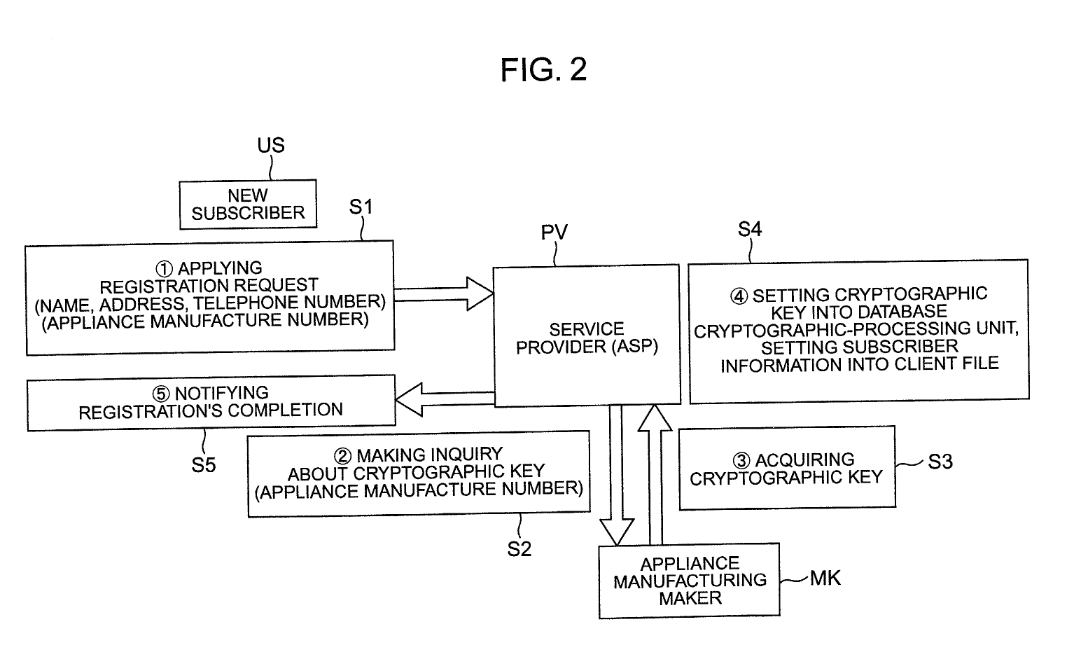

FIG. 2 illustrates a flow chart for the subscriber registration. The following registration processing is performed among a new subscriber US, a service provider (i.e., the ASP 7 illustrated in FIG. 1) PV, and an appliance manufacturing maker MK.

In a registration requesting application (S1) at \mathring{1}, the new subscriber US informs the service provider PV of the subscriber information such as his name, his address, and his telephone number, and the appliance manufacture number.

In a cryptographic key inquiry processing (S2) at \mathring{2}, the service provider PV that has received the registration request from the new subscriber US informs, of the appliance manufacture number, the appliance manufacturing maker MK with which the provider PV had cooperated in advance, thus making an inquiry about a cryptographic key corresponding to this appliance manufacture number.

In a cryptographic key acquisition processing (S3) at \mathring{3}, the appliance manufacturing maker MK, after confirming the service provider PV, informs the service provider PV of the cryptographic key that is in a one-to-one correspondence with the appliance manufacture number about which the inquiry has been made.

In a database setting processing (S4) at \mathring{4}, the service provider PV sets the subscriber information on the new subscriber US and the corresponding cryptographic key into the client file 10 and the database cryptographic processing unit 9, respectively, thereby configuring the database. The subscriber information includes a user ID formed of a name, a numeral string code, or the like. This user ID is utilized as one retrieving key to the database 8.

In a registration completion notice (S5) at \mathring{5}, the new subscriber US is notified that the subscriber registration processing has been completed and that it becomes possible to receive the provision of the electronic order-taking service.

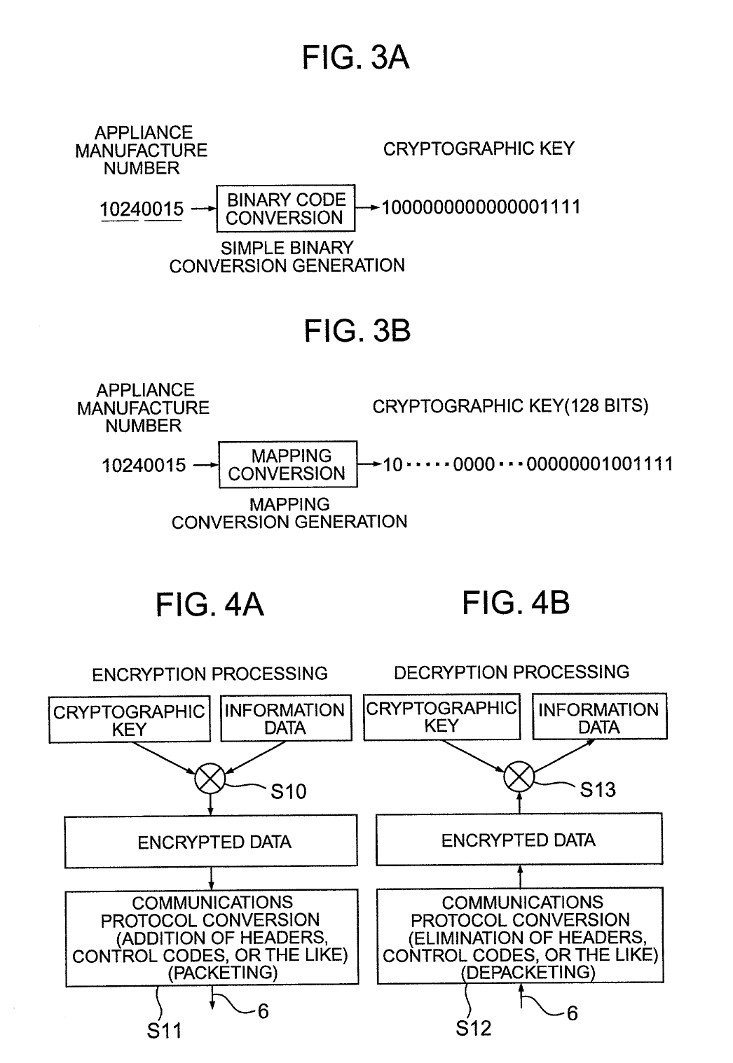

FIGS. 3A and 3B illustrate the one-to-one correspondence relationship between the appliance manufacture number and the cryptographic key. FIG. 3A illustrates an example of the simple binary conversion generation where a code obtained by converting the appliance manufacture number into the corresponding binary code is defined as the cryptographic key. In the drawing, the appliance manufacture number is separated every 4 digits, and the resultant 4-digit numerals are converted into the binary codes each, thereby generating the cryptographic key. Incidentally, the appliance manufacture number can be directly converted into the binary code. In this method, although the bit number of the cryptographic key is small, the cryptographic key becomes likely to be conjectured from the appliance manufacture number.

FIG. 3B illustrates an example of the mapping conversion generation where, for example, a 128-bit code is prepared as the cryptographic key, and the code caused to correspond in a one-to-one manner to the appliance manufacture number is defined as the cryptographic key. Naturally, since the number of digits of the code usable as the cryptographic key is by far larger as compared with the number of digits of the appliance manufacture number, the code that is actually used as the cryptographic key is only an extremely tiny part of the 128-bit code. Consequently, it is almost impossible to guess the cryptographic key from the appliance manufacture number. As a result, even if the appliance manufacture number is leaked to a third party, there is no possibility that the cryptographic key will be deciphered from the number. This results in an exceedingly high-safety.

As is apparent from the above-described explanation, in the present invention, it is completely unnecessary for the side of the terminal apparatus 1 to perform the operation concerning the cryptographic key, and it turns out that only the service providing side performs the operation of acquiring the cryptographic key. Moreover, after this cryptographic key has been acquired, the transmission/reception (i.e., the communications) of the information in the subsequent electronic order-taking service is performed using the data that has been encrypted by the common key cryptographic system based on this cryptographic key.

FIGS. 4A and 4B illustrate one example of an encryption processing and that of a decryption processing. At an encryption processing S10, the data in the electronic order-taking service, i.e., the information data, is converted into encrypted data by the cryptographic key. As its concrete processings, there are performed, e.g., the exclusive OR operation of the information data and the cryptographic key, and the transposition of the information data in accordance with the cryptographic key. Furthermore, by the communications protocol conversion (e.g., the packeting, the addition of the various types of headers and control codes, or the like), this encrypted data is converted into data that is in the format in accordance with communications protocols of the access networks (S11), then being sent via the access networks 6.

Meanwhile, the data sent via the access networks 6, at first, by the communications protocol conversion (S12), is subjected to processings of the elimination of the various types of headers and control codes, and of the depacketing, and thereby the data is decrypted back to the encrypted data. In addition, this encrypted data is decrypted back to the information data by the cryptographic key (S13). For example, in the encryption processing based on the exclusive OR operation, the exclusive OR operation of the encrypted data and the cryptographic key is performed, thereby decrypting the information data. Also, in the encryption processing based on the transposition of the information data, the retransposition of the encrypted data by the cryptographic key is performed, thereby decrypting the information data.

Consequently, in the electronic order-taking service, on a line ranging from the terminal apparatus 1 in FIG. 1 via the equipment-based home network 4 to the gateway 5, and in an interface unit of the ASP 7, the transmission/reception is performed using this encrypted data. Also, in the communications between the gateway 5 and the ASP 7 via the access networks 6 (e.g., the public line, the power line, and the like), the transmission/reception is performed using the data obtained by converting the encrypted data into the format in accordance with the communication protocols. This prevents private information on the subscriber from leaking to the outside, thereby implementing an exceedingly high-safety.

As described earlier, the cryptographic processing unit 9 in the ASP 7 performs the predetermined encryption processing by the cryptographic key acquired with the appliance number employed as the source. Moreover, as will be described later, based on the system configuration including the database 8, the client file 10, the application server 11, and the WEB server 12, there are provided the various types of services such as the failure report and the life-reaction report in addition to the electronic order-taking service.

<<Concrete Embodiments of Terminal Apparatus>>

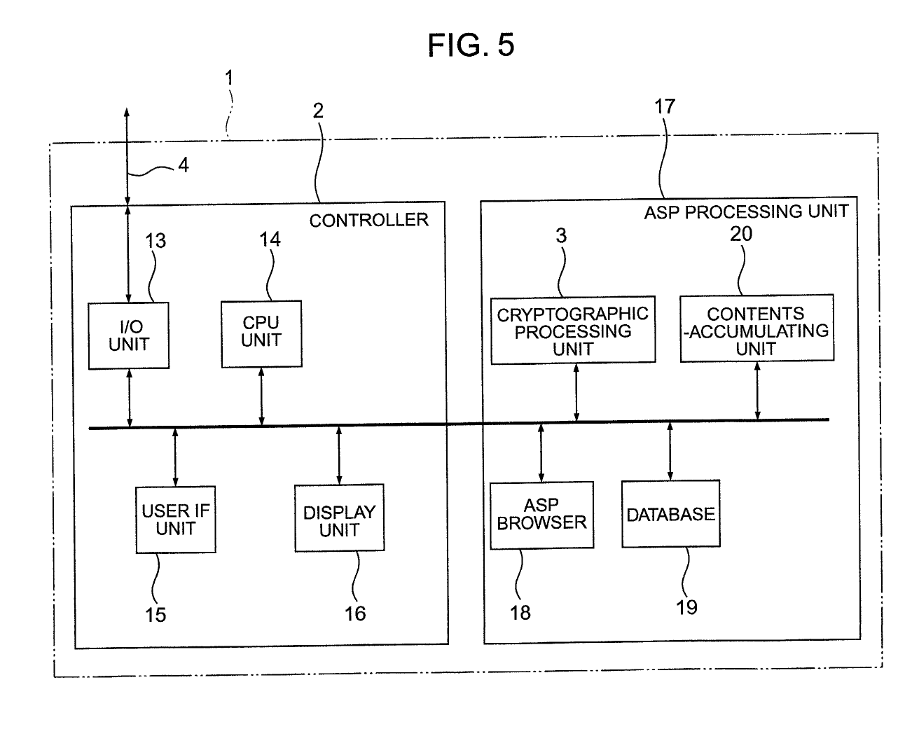

FIG. 5 illustrates a first embodiment of the terminal apparatus 1. The terminal apparatus 1 includes the controller 2 and the ASP processing unit 17. Of these, the controller 2 mainly controls the domestic electrical apparatuses connected to the Echonet as the equipment-based home network, and includes the following configuration components. An input/output (I/O) unit (i.e., communication means) 13 for performing the input/output control with the equipment-based home network, a CPU unit (i.e., data processing means) 14 for controlling and executing the various types of signal processings and information processings, a user interface (IF) unit (i.e., operating means) 15 for providing an easy-to-use user interface, and a display unit 16 for displaying the various types of information. Incidentally, the display unit 16 is also co-used for displaying the various types of information in the net-order sale services such as the electronic order-taking service.

The ASP processing unit 17 mainly executes the net-order sale services such as the electronic order-taking service, and includes the following configuration components. The cryptographic processing unit 3, an ASP browser 18 for executing the various types of net-order sale services, a database 19 for accumulating/managing the various types of information on the subscribers, and a contents-accumulating unit 20 for memorizing electronic catalogues or the like. The ASP processing unit 17 outputs the data converted into the encrypted data by the cryptographic processing unit 3. The data sent from the service providing side is decrypted back to the original data by the cryptographic processing unit 3.

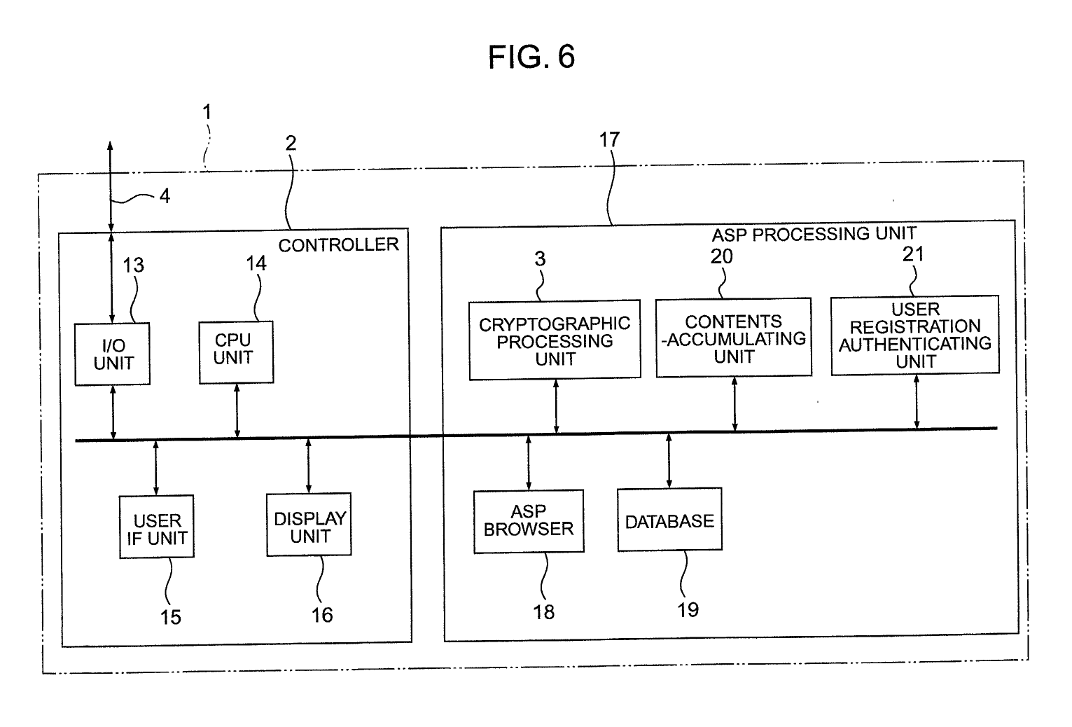

FIG. 6 illustrates a second embodiment of the terminal apparatus 1. This embodiment differs from the embodiment in FIG. 5 in a point that there is provided a function of limiting, to an in-advance registered person, the user of the electronic order-taking service within the Echonet. This function is implemented by a configuration where a user registration authenticating unit 21 is added to the ASP processing unit 17. Although not explicitly shown in the drawing, this user registration authenticating unit 21 is implemented by the following functions. A function of registering the features capable of specifying the operator using the user IF unit 15, e.g., the fingerprints, the voiceprint, the iris, or the like, a function of judging whether or not the reference data coincides with the registration data, and a function of displaying, if the reference data does not coincide therewith, the state where the user of the electronic order-taking service has been unregistered and thus the service will not be put into operation. This authenticating technology itself can be easily implemented by taking advantage of the well-known technologies.

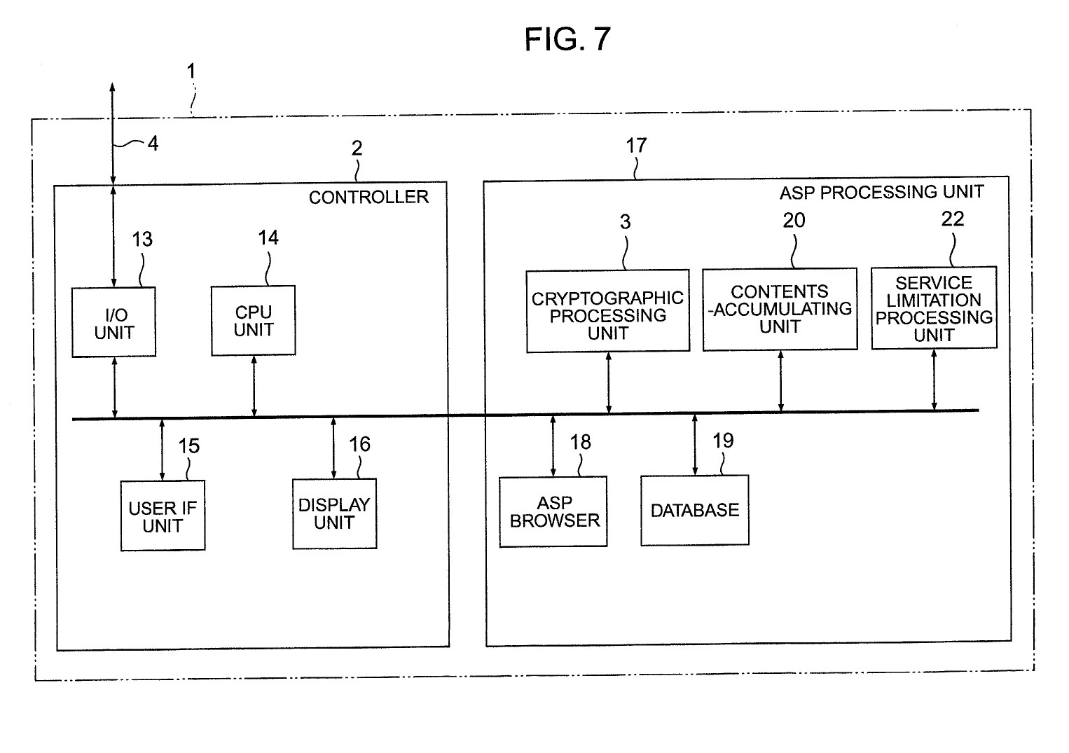

FIG. 7 illustrates a third embodiment of the terminal apparatus 1. This embodiment differs from the embodiment in FIG. 5 in a point that the following function is added thereto. Setting in advance an upper-limit of the purchase money-amount or the purchase quantity in the electronic order-taking service so as to define the limitation by the upper-limit as a one-time or one-day utilization limit on the electronic order-taking service. This function is implemented by a configuration where a service limitation processing unit 22 is added to the ASP processing unit 17. Although not explicitly illustrated in the drawing, this service limitation processing unit 22 includes the following functions. An in-advance registering function of storing the in-advance registered purchase money-amount or purchase commodities' items, an examining function of judging whether or not the money-amount or quantity of the commodities ordered in the electronic order-taking service is larger than the in-advance registered data, and a function of displaying, if the money-amount or the quantity is larger than the in-advance registered data, the state where the service will not be put into operation because of the larger purchase money-amount or purchase quantity. These purchase limiting functions themselves can be easily implemented by taking advantage of the well-known technologies.

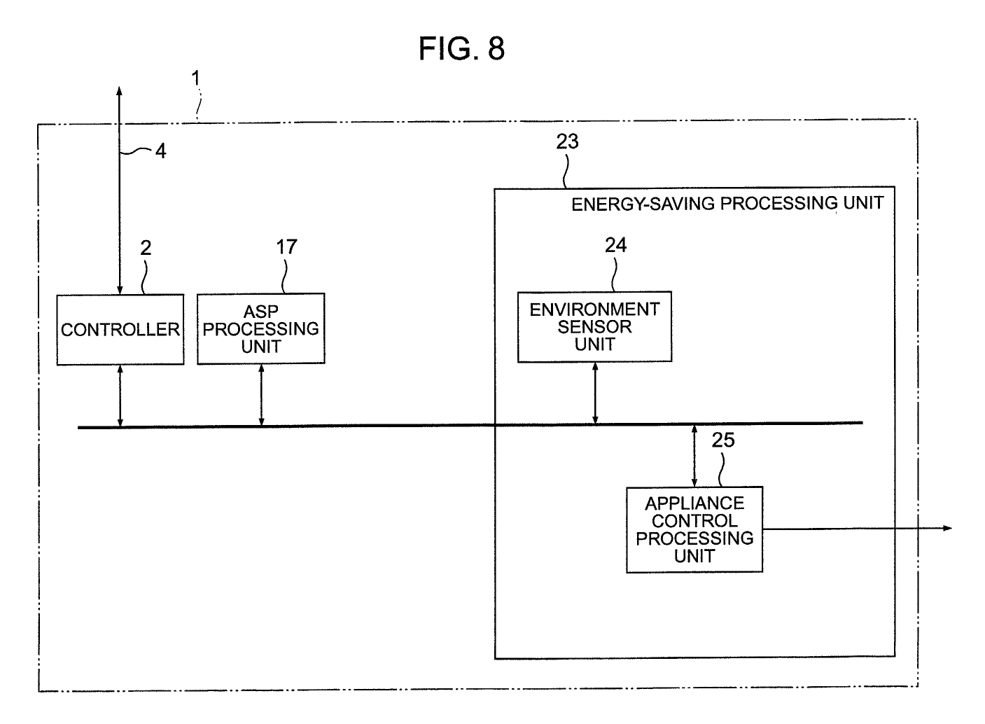

FIG. 8 illustrates a fourth embodiment of the terminal apparatus 1. This embodiment differs in a point that an energy-saving processing unit 23 is further added to the controller 2 and the ASP processing unit 17 indicated in any one of the first to third embodiments. This energy-saving processing unit 23 includes an environment sensor unit 24 and an appliance control processing unit 25. The environment sensor unit 24, from a sensor or the like attached to the domestic electrical apparatus or the like, collects information on the temperatures on the periphery of the apparatus, the intra-room temperature, or the like. In addition, the appliance control processing unit 25 generates a signal or the like for controlling the working of the domestic electrical apparatus so that the energy-saving operation of the apparatus suitable for these temperatures and the intra-room temperature will be performed. This environment sensing and the appliance control based thereon themselves can be easily implemented by taking advantage of the well-known technologies.

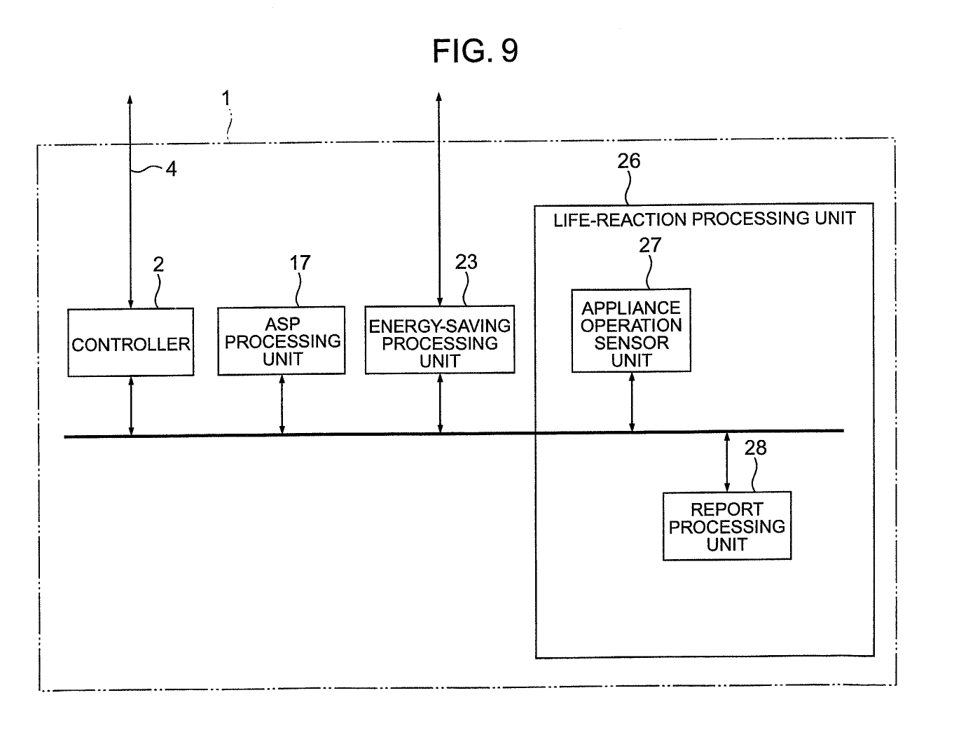

FIG. 9 illustrates a fifth embodiment of the terminal apparatus 1. This embodiment differs from the above-described embodiments in a point that there is provided functions regarding the life-reaction report and the failure report. Accordingly, this embodiment is newly provided with a life-reaction processing unit 26 including an appliance operation sensor unit 27 and a report processing unit 28. The appliance operation sensor unit 27 detects, for example, whether or not the opening/closing of the refrigerator's door has been performed. In addition, the life-reaction processing unit 26 has a function of judging that there exists no life-reaction if this opening/closing action has been not performed during a predetermined time-period, and of making an abnormality report to the outside via the report processing unit 28.

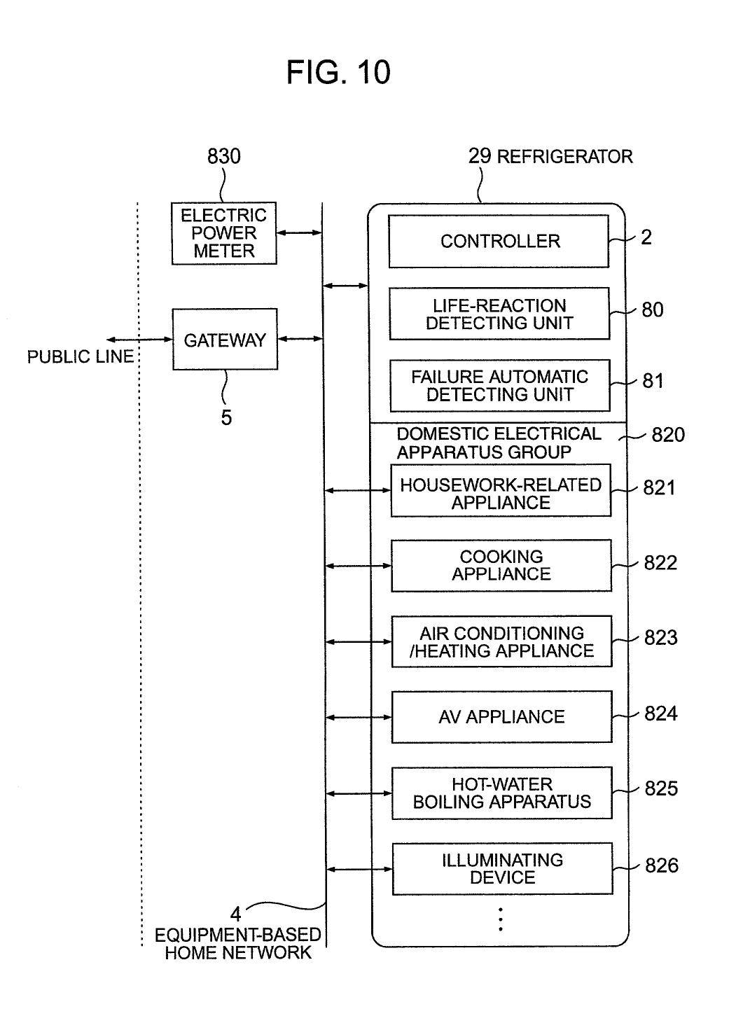

FIG. 10 illustrates an embodiment where the terminal apparatus 1 provided with the life-reaction detecting function explained in FIG. 9 is applied to the refrigerator. FIG. 10 illustrates a plurality of Echonet-connected domestic electrical apparatuses with a refrigerator 29 having the terminal apparatus 1 employed as the center. In the same drawing, the refrigerator 29 has a function of being capable of performing the transmission/reception (i.e., the communications) of the information with the service providing side via the gateway 5. The transmission/reception is performed by the specifically-designed controller 2 including an operating unit such as a touch-panel type monitor (not illustrated). Also, the refrigerator 29 has a life-reaction detecting unit 80 and a failure automatic detecting unit 81. The domestic electrical apparatus group 820 connected to the equipment-based home network 4 involves housework-related appliances 821 whose representatives are a washing machine and a dryer, cooking appliances 822 whose representatives are a microwave oven and a rice cooker, air conditioning/heating appliances 823 whose representatives are an air conditioner and a kotatsu, AV (i.e., Audio Visual) appliances 824 whose representatives are a television and a videocassette recorder, hot-water boiling apparatuses 825 whose representatives are an electric water heater and an electric thermos bottle, and illuminating devices 826 whose representative is a fluorescent lamp. Each of these Echonet-connected domestic electrical apparatuses has an ID (i.e., Identifier). These IDs are registered into the refrigerator 29, i.e., the concentration controlling apparatus, and the IDs are utilized as report information to a failure automatic detecting unit described later and the service providing side. Moreover, an electric power meter 830 for monitoring the power consumption quantity is connected to the equipment-based home network 4, thereby allowing the information on the power consumption quantity to be utilized as the later-described failure automatic detecting unit for the domestic electrical apparatuses.

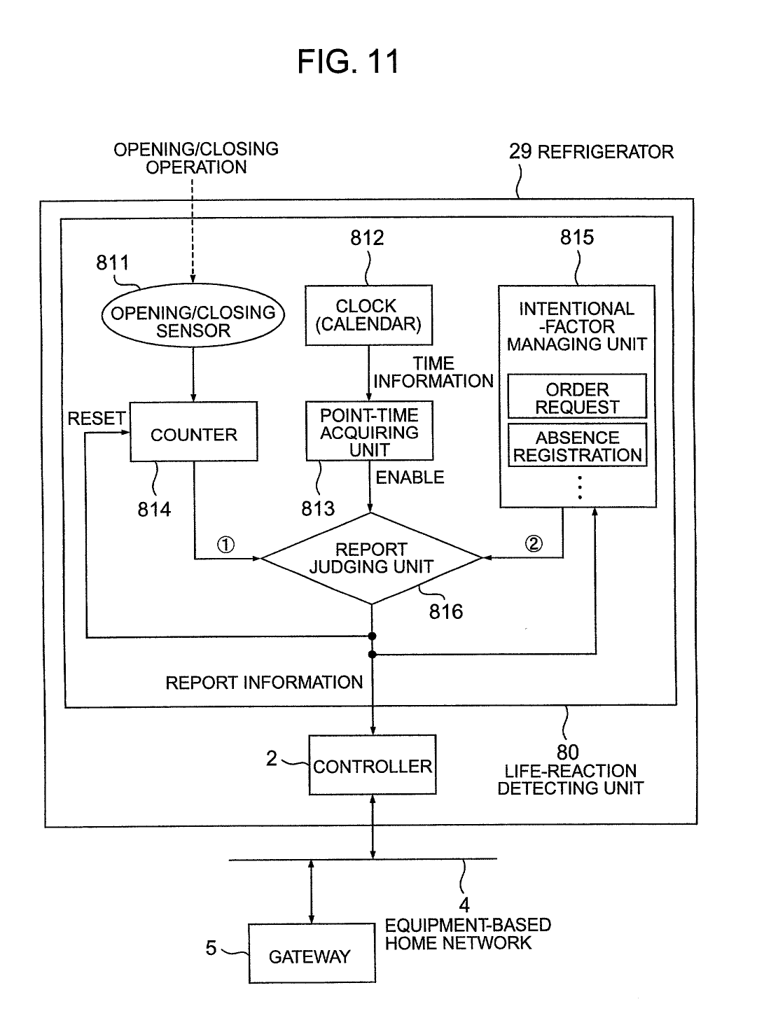

FIG. 11 illustrates the details of the life-reaction reporting function by the life-reaction detecting unit 80 in FIG. 10. The life-reaction reporting function is, for example, a function of detecting an abnormality at the home of a person who lives alone, especially an elderly person or a physically disabled person who lives alone, and of automatically reporting the abnormality to the service providing side so as to avoid an unexpected situation. In this embodiment, although not particularly specified, the action information based on the opening/closing of the refrigerator is grasped, thereby configuring the life-reaction reporting system.

In FIG. 11, the refrigerator 29 has the life-reaction detecting unit 80, and the reporting mechanism is as follows. The life-reaction is confirmed by the life-reaction detecting unit 80, then being automatically reported to the service providing side. As illustrated in the same drawing, the life-reaction detecting unit 80 includes the following configuration components. An opening/closing sensor 811 for detecting the opening/closing of the refrigerator's door, a clock 812 for managing date and time, a counter 814 for counting the opening/closing actions of the refrigerator, a point-time acquiring unit 813 for detecting a predetermined time from the clock 812 so as to generate an enable signal, a report judging unit 816 for judging whether to send the life-reaction report information or not, and an intentional-factor managing unit 815 for managing an order request for food material, absence information, and the like.

At first, the opening/closing operation of the door of the refrigerator 29 activates the opening/closing sensor 811, thereby sending door opening/closing information (i.e., signal) to the counter 814 to start up the counter 814. Namely, it turns out that the counter value of the counter 814 is counted up every time the opening/closing action of the refrigerator's door is performed. The information \mathring{1} on the counter value of the counter 814 is supplied to the report judging unit 816 all the time. Meanwhile, information \mathring{2} on the intentional factors, e.g., whether or not the user has made an order request for food material within the day, whether or not the user is at home at the moment, and the like, is also supplied to the report judging unit 816 from the intentional-factor managing unit 815. Based on the above-described information \mathring{1} and \mathring{2}, and taking into consideration conditions concerned, the report judging unit 816 performs the judging processing about the sending of the life-reaction report information as described earlier. The judging processing by the report judging unit 816 is performed at a predetermined time every day. Here, the point-time acquiring unit 813 in the present configuration always monitors the time information generated by the clock 812. When the preset time (i.e., timing) comes, the unit 813 generates and outputs an enable signal for the judging processing toward the report judging unit 816. The report judging unit 816 performs the report judging processing in response to the notice of this enable signal, then supplying the controller 2 with the processing result as the report information. At the same time, the report information (i.e., signal) is feed-backed to the counter 814 as well. Having received the report information, the counter 814 resets the counting operation, then newly starting the counting of the opening/closing operation of the refrigerator's door. Similarly, the report information is feed-backed to the intentional-factor managing unit 815 as well, thereby clearing the factors' contents.

As is obvious from the explanation of the above-described operation, in the case where the access to the refrigerator 29 has been not performed during a fixed time-period, the report judging unit 816 turns out to issue a meaningful report information. Naturally, the controller 2 is connected to the equipment-based home network 4, and thus the life-reaction report information is sent to the service providing side via the gateway 5. The service providing side, based on such a life-reaction report information, performs the reconfirmation of the situation toward the service demanding side. Simultaneously, in substitution for the demanding side, the providing side makes contact with the concerned parties defined in the contract, e.g., the related parties such as a relative, a local self-government, and a hospital.

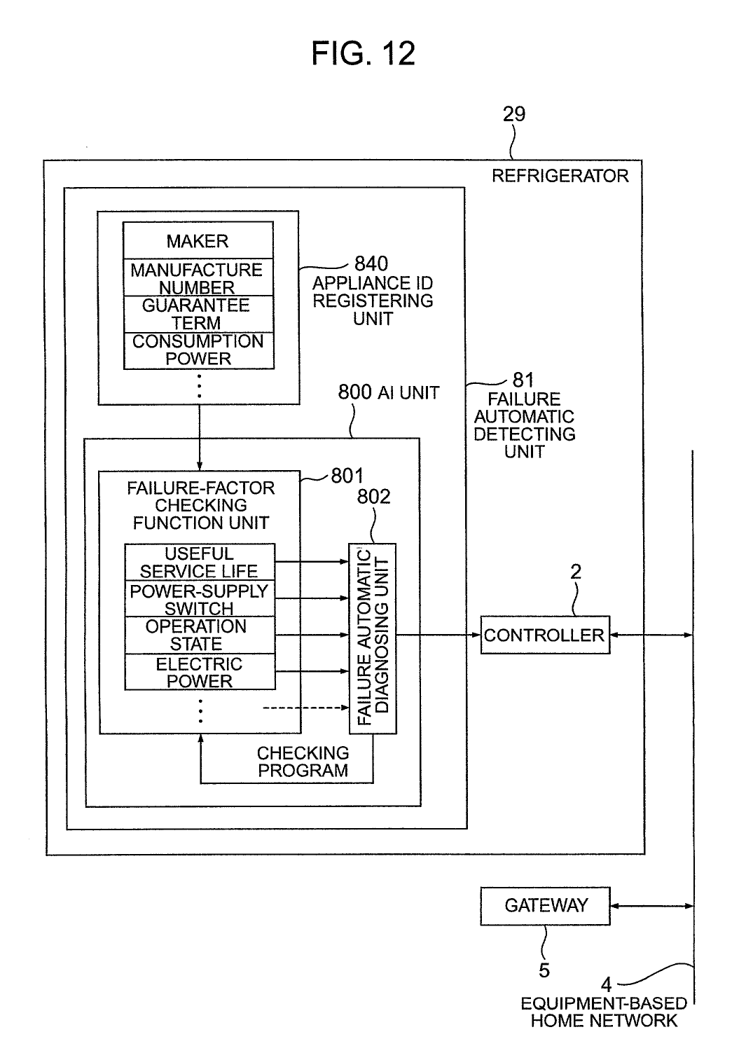

FIG. 12 illustrates the details of the failure automatic reporting function by the failure automatic detecting unit 81 in FIG. 10. The failure automatic reporting function is, for example, a function of automatically detecting a failure or the like of a domestic electrical apparatus connected to the Echonet, and of automatically reporting the information to the service providing side so that the domestic electrical apparatus will be able to undergo the repair, the maintenance, or the like.

In FIG. 12, the failure automatic detecting unit 81 that becomes a key unit to the failure automatic reporting system includes an appliance ID registering unit 840 and an AI (i.e., Artificial Intelligence) unit 800. The appliance ID registering unit 840 stores the data (i.e., information) specific to each of the Echonet-connected domestic electrical apparatuses, such as the maker, the manufacture number, the guarantee term, and the consumption power. When a domestic electrical apparatus is newly purchased, or when the maintenance/checking of an existing domestic electrical apparatus is performed, the contents of the appliance ID registering unit 840 is updated. The AI unit 800 includes a failure-factor checking function unit 801 and a failure automatic diagnosing unit 802. Moreover, the failure-factor checking function unit 801 includes checking functions for checking the useful service life, the power-supply switch, the operation state, the electric power, and the like. The useful-service-life checking function is a function of checking the life expectancy and the guarantee term of each domestic electrical apparatus. The power-supply switch checking function is a function of checking the ON/OFF situation of the power-supply switch of each domestic electrical apparatus connected to the Echonet. The operation state checking function is a function of checking the working situation of the sensor attached to each domestic electrical apparatus so as to check an actual operation abnormality. The electric power checking function is a function of checking whether or not a normal electric power value is maintained in accompaniment with the operation state of each domestic electrical apparatus.

In the AI unit 800, with respect to the above-described checking functions by the failure-factor checking function unit 801, a series of checking programs supplied from the failure automatic diagnosing unit 802 are executed. Then, the checking result information obtained from the execution is sent to the failure automatic diagnosing unit 802. Also, in the respective checking processings by the failure-factor checking function unit 801 in the process of executing the checking programs, the checking processings are performed while fetching the information in the above-described appliance ID registering unit 840 as required. Moreover, based on the checking result information sent from the failure-factor checking function unit 801, the failure automatic diagnosing unit 802 makes a failure judgement, a maintenance judgement, or the like on each domestic electrical apparatus connected to the Echonet, then sending the resultant judgement information to the controller 2. From the controller 2, the information processed in the failure automatic detecting unit 81 is reported to the service providing side via the equipment-based home network 4 and the gateway 5. Incidentally, it is needless to say that, concerning the failure or maintenance judgement information reported to the service providing side, the reconfirmation will be performed from the service providing side to the service demanding side.

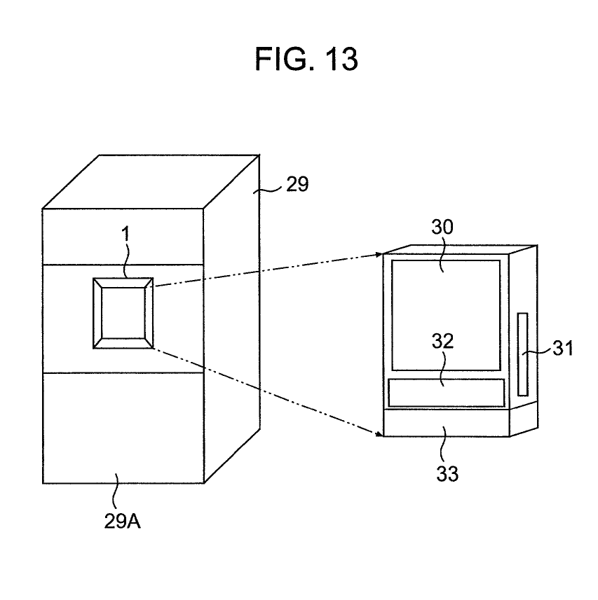

FIG. 13 illustrates the outside appearance of the refrigerator onto which the terminal apparatus has been integrated. Since the structure and the functions of the refrigerator itself have been well-known, the detailed explanation thereof will be omitted here. The terminal apparatus 1 has been implemented onto a central door 29A of the refrigerator 29. The advantages resulting from implementing the terminal apparatus 1 onto the refrigerator 29 are the following points. The refrigerator 29 is current-carrying all night and the power thereto is turned on all the time, and thus it is convenient to employ the refrigerator as the main element of the Echonet. Furthermore, a wide space is easy to take as a settable place of the terminal apparatus 1, and the number of access times thereto is generally large.

As illustrated in an enlarged manner in FIG. 13, the terminal apparatus 1 includes a picture displaying unit 30, an external memory inputting unit 31, an operating panel unit 32, and a printer unit 33 as an option. Of these units, the picture displaying unit 30 is used for a guide display and an input display in the electronic order-taking service or the like. Also, the external memory inputting unit 31 is used as an inputting unit of a medium such as an electronic catalogue or the like. Moreover, the operating panel unit 32 has buttons or the like for executing the various types of functions. The printer unit 33, although not necessarily essential, is convenient for printing out necessary information.

Concerning the power feeding to the terminal apparatus 1, although not explicitly illustrated in the drawing, there is provided a mechanism for feeding the power from the refrigerator side. Also, the terminal apparatus 1 itself can also be removed from the refrigerator so as to be used as a single stand-alone apparatus.

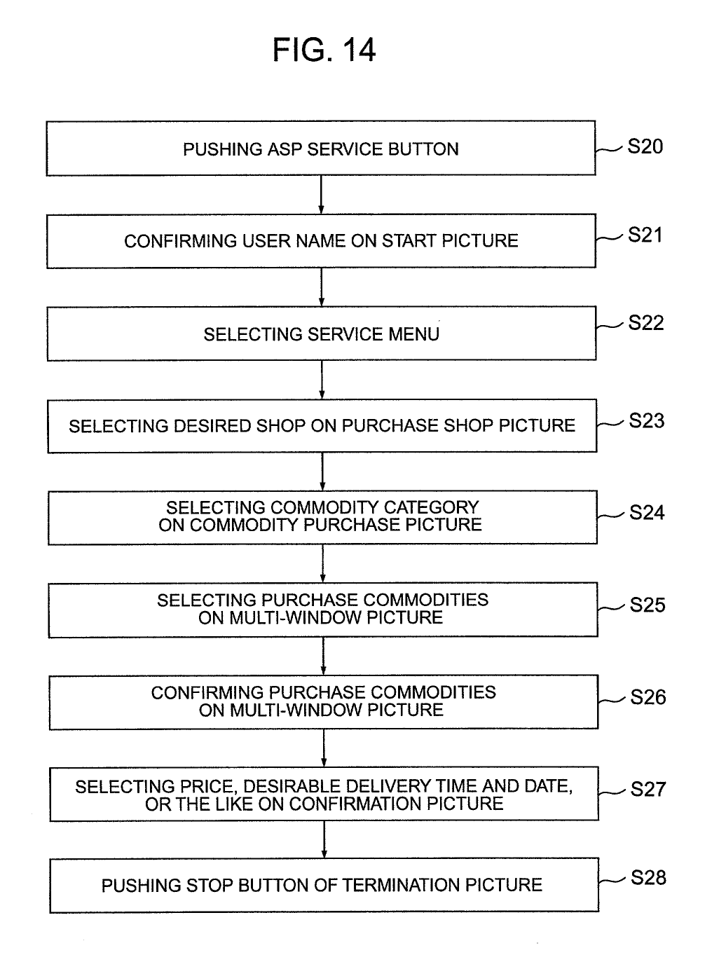

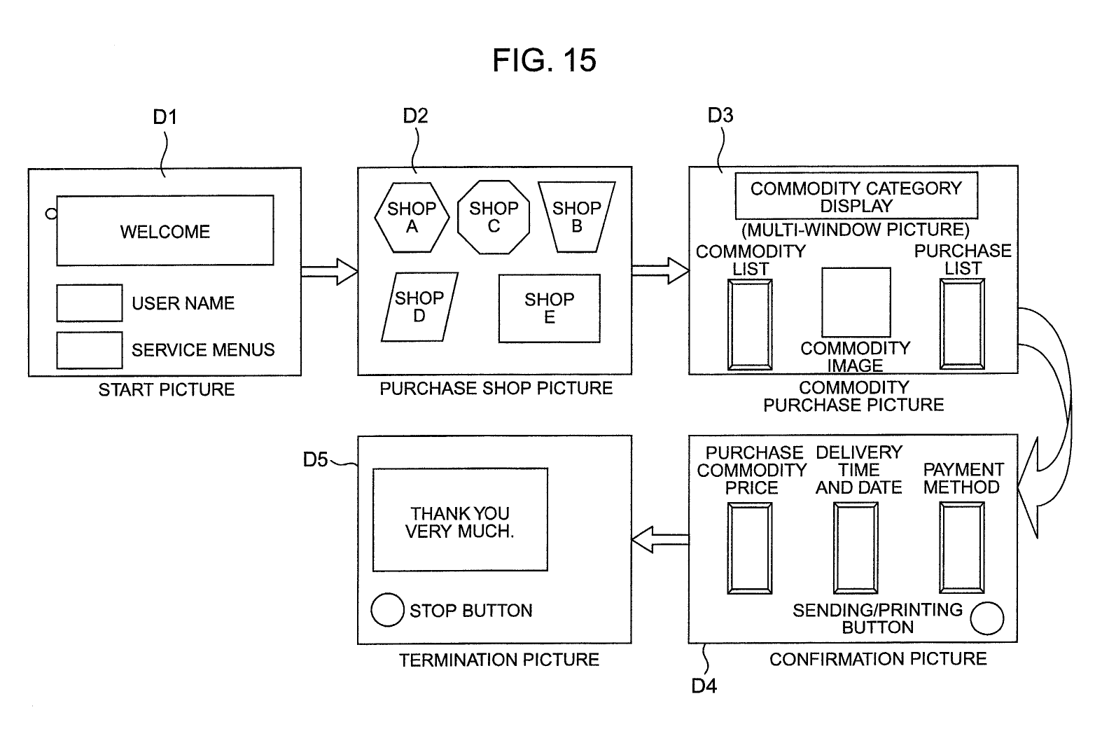

FIG. 14 illustrates the operating steps of the ASP service such as the electronic order-taker by the terminal apparatus 1. FIG. 15 illustrates displayed examples of the display pictures provided by the ASP service.

As illustrated in FIG. 14, by pushing an ASP service button on the operating panel unit 32 of the terminal apparatus 1 (S20), the controller 2 is switched to an execution mode of the ASP service. Moreover, the picture displaying unit 30 displays a start picture (D1) illustrated in FIG. 15, thus displaying the user name and the service menus. On this picture, the user confirms the user name (S21), then selecting, from among the service menus, a service menu that the user wishes to execute (S22). For example, if the user selects commodity purchase, the display picture becomes a purchase shop picture (D2) illustrated in FIG. 15. Then, in accordance with the corresponding operating step illustrated in FIG. 14, the user selects a shop that the user desires (S23). Thus, the display picture becomes a commodity purchase picture (D3) illustrated in FIG. 15.

On this commodity purchase picture (D3), in accordance with the corresponding operating step illustrated in FIG. 14, the user selects a category of purchase commodities from a commodity category display of, e.g., vegetable, meat, fish, dairy product, or the like (S24). In addition, making reference to the commodity list and the commodity images displayed on multi windows on the commodity purchase picture (D3), the user selects the commodities that the user wishes to purchase (S25). Also, the list of the selected commodities is displayed on a purchase list. Furthermore, after selecting the necessary purchase commodities, the user selects a confirmation button (not explicitly illustrated in the drawing) for the purchase list picture.

Then, as illustrated in FIG. 15, the display picture is switched to a confirmation picture (D4). Here, in accordance with the corresponding operating step illustrated in FIG. 14, the user confirms and specifies the purchase commodities, the prices, the delivery time and date, and the payment method (S26 and S27).

Then, the display picture is switched to a termination picture (D5) in FIG. 15, on which pushing a stop button terminates the execution of the ASP service (S28). Incidentally, when executing the ASP service continuously, the user selects a continuation button (not explicitly illustrated in the drawing). Then, the display picture is switched to the purchase shop picture, and hereinafter, the user executes the ASP service in accordance with the same operating steps.

Additionally, the display pictures are configured using, e.g., a touch-panel type monitor or the like, where touching the corresponding item on the picture allows the item selection to be performed.

<<Concrete Embodiments of Host Apparatus (ASP)>>

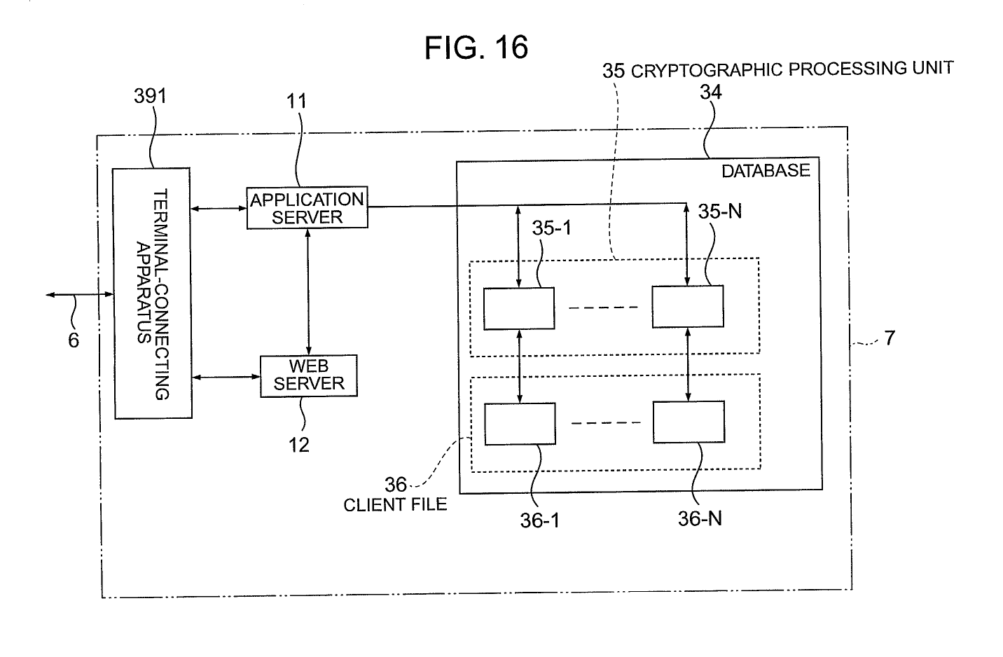

FIG. 16 illustrates a first embodiment of the ASP 7. The ASP 7 is implemented using a terminal-connecting apparatus 391, the application server 11, the WEB server 12, the database 34, the cryptographic processing unit 35, and the client file 36.

The application server 11 is a server having the various types of application programs needed for executing the electronic order-taking service or the like. Also, the WEB server 12 executes the various types of information services on the Internet. The terminal-connecting apparatus 391 is a circuit for connecting the application server 11 and the WEB server 12 to the access networks 6.

The database 34 manages the data on the respective subscribers of the electronic order-taking service. Moreover, on each subscriber basis, the database 34 is constructed using the cryptographic processing unit 35 (including 35-1 to 35-N) and the client file 36 (including 36-1 to 36-N). In addition, as described earlier, the cryptographic processing unit 35, on each subscriber basis, acquires the cryptographic key from the appliance number of the subscriber at the time of the subscriber registration. Furthermore, using this acquired cryptographic key, the unit 35 performs the data encryption processing and the data decryption processing. Accordingly, the cryptographic processing unit 35 (including 35-1 to 35N) has the cryptographic keys that are specific to the respective subscribers. Namely, the information sent from the terminal apparatus 1 is decrypted by the cryptographic processing unit 35 of each subscriber, then being recorded into the client file 36. Also, the data in the client file 36 is encrypted by the cryptographic processing unit 35, then being sent to the information terminal 1.

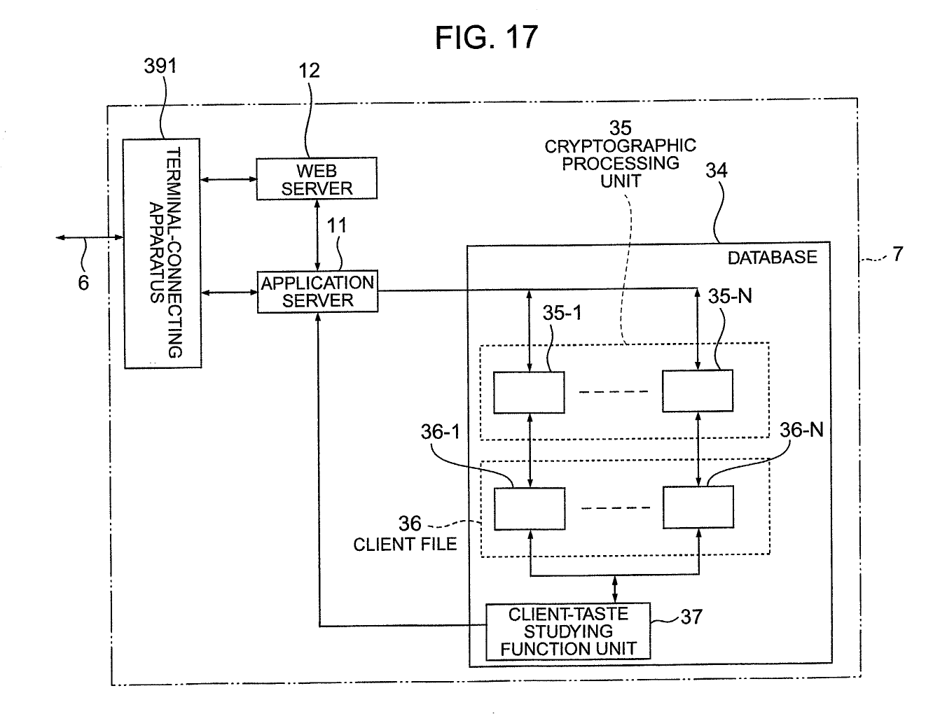

FIG. 17 illustrates a second embodiment of the above-described ASP 7. The ASP 7 illustrated in the same drawing differs from the configuration in FIG. 16 in a point that a client-taste studying function unit 37 is added thereto. This client-taste studying function unit 37 has a function of analyzing/studying the subscriber's purchase taste, purchase money-amount, or the like. Based on this analysis/study result, the present ASP 7 implements the provision of the ASP service that has been made more fine-grained on each subscriber basis.

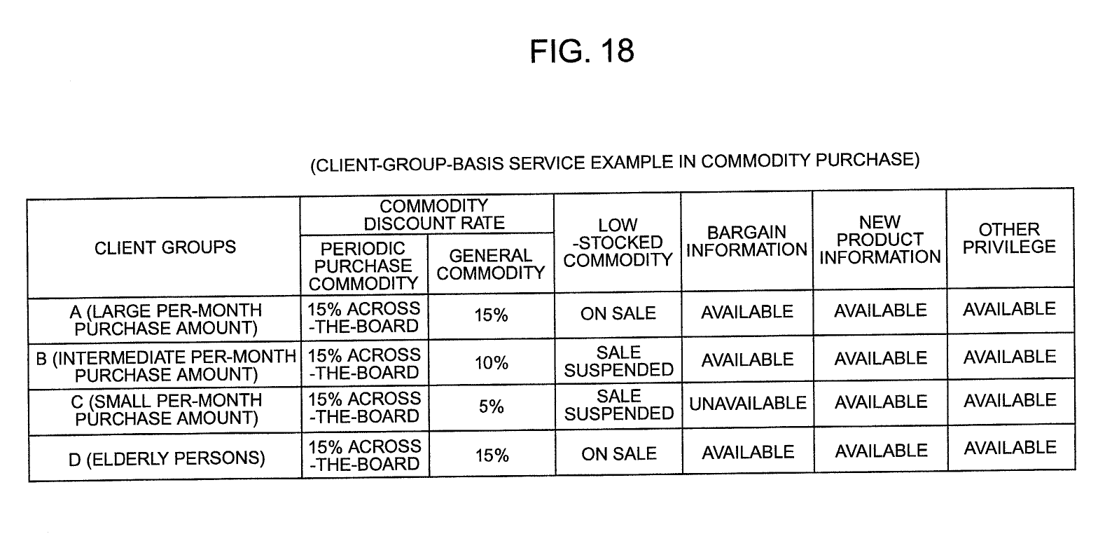

FIG. 18 illustrates one example of the service by the client-taste studying function. The service example in the same drawing is a service example accompanying the commodity purchase. As illustrated in FIG. 18, the client group is classified into an “A” group whose per-month purchase money-amount is large, a “B” group whose per-month purchase amount is intermediate, a “C” group whose per-month purchase amount is small, and a “D” group of elderly persons. Moreover, on each group basis, the fine-grained setting has been made concerning commodity discount rate, sale of low-stocked commodity, bargain information, new product information, and the others, e.g., privilege or the like.

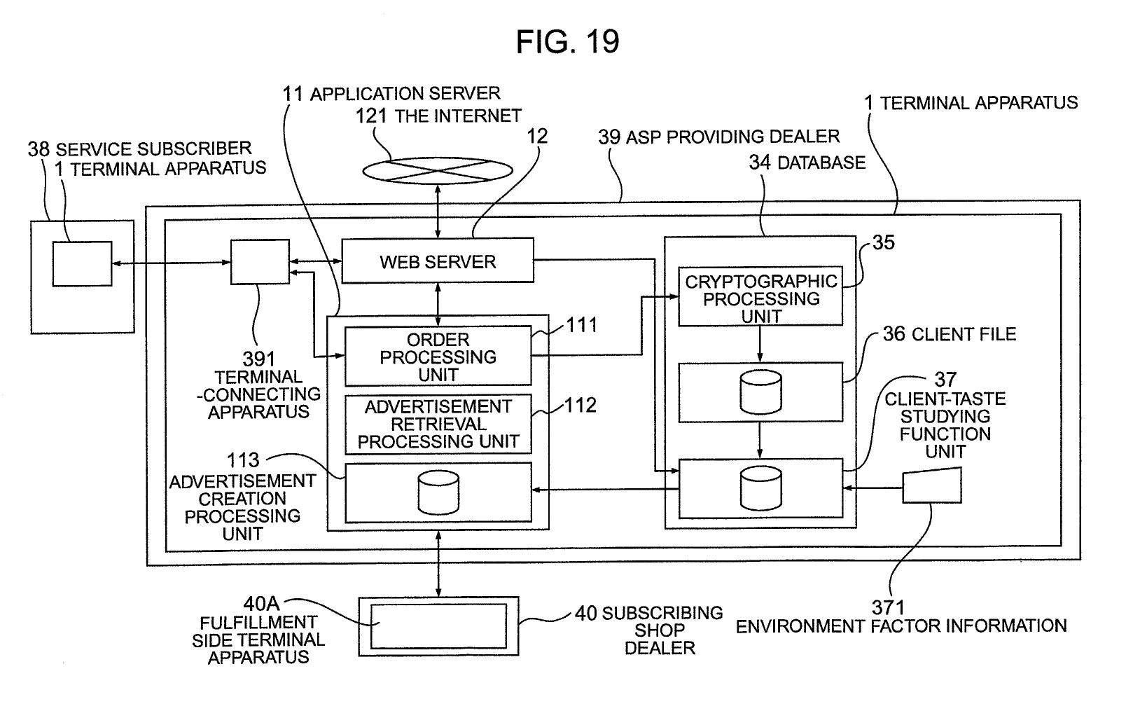

FIG. 19 illustrates still another embodiment of the ASP 7 where attention has been focused on the client-taste studying function unit 37. The client-taste studying function unit 37 functions in cooperation with an order processing unit 111, an advertisement retrieval processing unit 112, and an advertisement creation processing unit 113 which are located in the application server 11. Here, the WEB server 12 is connected to the Internet 121.

The functions implemented by this client-taste studying function unit 37 are the following functions. (1) The accumulation of order information, (2) the accumulation of retrieval information, and (3) the retrieval of client information.

The accumulation of the order information in (1) is a processing of accumulating the order information on each client (i.e., service subscriber) basis. Here, the order information means information at the time when, using the terminal apparatus 1, the service subscriber 38 gave an order for a commodity provided by a subscribing shop dealer 40. Concretely, the order information refers to the name of the commodity, the classification code thereof, the money-amount thereof, the time and date at having given the order, and whether or not the order originates from the advertisement's reference. The order information itself is processed by the order processing unit 111. The information on the ordered commodity is transmitted to a terminal apparatus (i.e., fulfillment side terminal apparatus in response to the order) 40A of the subscribing shop dealer 40 that will deliver the ordered commodity.

The accumulation of the retrieval information in (2) is a processing of accumulating the retrieval information on each client basis. Here, the retrieval information means information at the time when, using the terminal apparatus 1, the service subscriber 38 retrieved the commodity that he or she had wished to purchase. Concretely, the retrieval information refers to the commodity type retrieved and the time and date at having performed the retrieval. The retrieval information itself is processed by the advertisement retrieval processing unit 112, and the retrieved advertisement information is sent to the service subscriber 38.

Also, in addition to the information accumulated as described above, environment factor information 371 is also accumulated which refers to the following. The time and date (i.e., day of the week, weekday/day before holiday/holiday, or the like), the time zone, and the climate (i.e., weather, temperature, or the like) at the time when the order information or the retrieval information was received.

Furthermore, each service subscriber 38 is also capable of registering in advance, into this client-taste studying function unit 37, a list of the commodity advertisements that he or she wishes to be delivered.

The retrieval of the client information in (3) is a processing where, when creating an advertisement by using the advertisement creation processing unit 113, the subscribing shop dealer 40 retrieves the order information or the retrieval information in the past. This processing is utilized when determining the contents of the advertisement and a service subscriber to which the advertisement is to be sent.

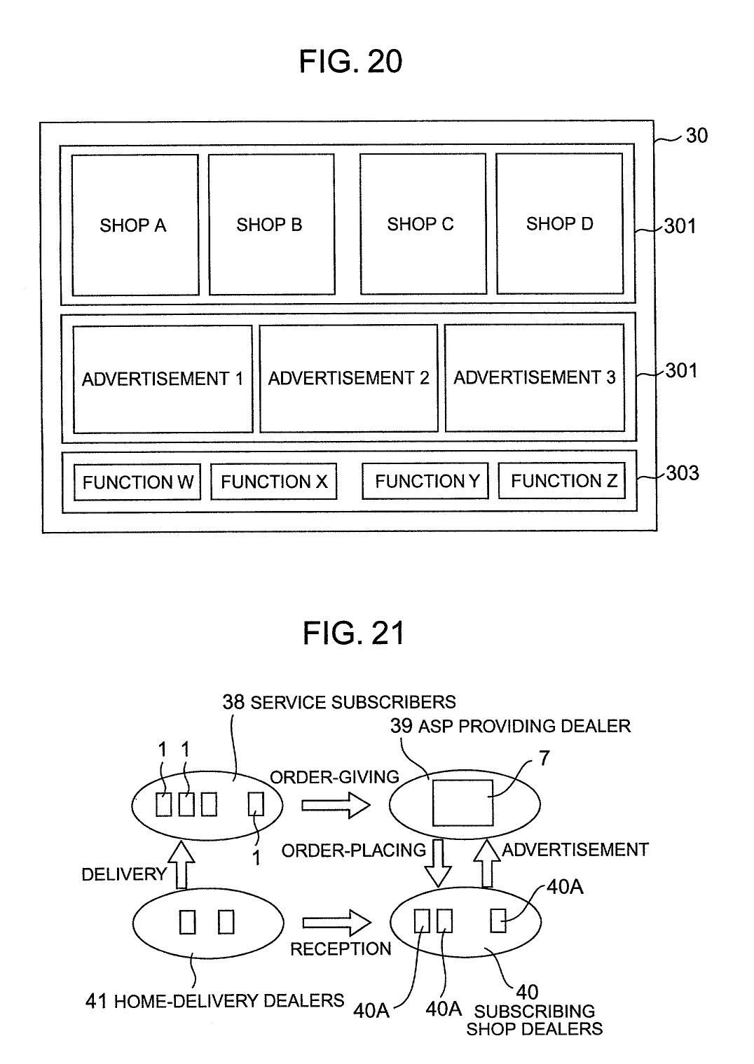

FIG. 20 illustrates the advertisement picture created by the advertisement creation processing unit 113. This advertisement picture is displayed on the picture displaying unit 30 of the terminal apparatus 1. The picture includes 3 portions. The upper stage is of a purchase shop list 301, which displays a list of the subscribing shop dealers 40. The intermediate stage is of an advertisement list 302, which displays a plurality of advertisements presented by the subscribing shop dealers 40. The lower stage is of a function list 303, which displays a list of buttons for performing the services other than the order available from the terminal apparatus 1.

The advertisements presented by the subscribing shop dealers 40 are displayed either on the advertisement list 302 in FIG. 20 or on the commodity category display (i.e., D3 in FIG. 15) that appears after the service subscriber 38 has selected a certain purchase shop dealer out of the purchase shop list 301. The advertisements displayed on the advertisement list 302, the number of which is limited though, exhibit a magnificent advertising effect. This is because the service subscriber 38 never fails to see the advertisements when he or she utilizes the terminal apparatus 1. If a commodity that the subscriber 38 desires exits within the advertisement list 302, the subscriber specifies the commodity box, thereby being capable of selecting the picture for purchasing the commodity.

The advertisement creation processing unit 113 illustrated in FIG. 19 has the following 3 functions. (1) The retrieval of the taste information, (2) the selection of an advertisement-delivering method, and (3) the creation and delivery of the advertisement picture.

The retrieval processing of the taste information in (1) is a processing of retrieving, from a variety of angles, the information accumulated in the client-taste studying function unit 37, and information accumulated in the client-taste studying function units in the other areas of the ASP service providing dealer 39 and collected via the Internet 121. There exist 3 types in the usage of the taste information retrieval.

A first usage is the following retrieval. The commodity genre and the advertisement publishing time and date are determined and, from the registration information, commodities that are likely to be sold during the time-period are retrieved and ranked. For example, from the information in the past, the retrieval is performed as to what day of the week the advertisement publishing day in the past was and whether or not the day was a holiday, including the weather forecast of the day. Otherwise, target purchasers can be retrieved on each client-group basis (i.e., the classification according to the purchase frequency, the age, and the gender of the purchasers). This retrieval makes it possible to support the determination of the commodities to be published on the advertisement.

A second usage is the following retrieval. The commodity genre, or a list of commodities that the subscribing shop dealer 40 deals in and the advertisement publishing time and date (or the publication scheduled time-period) are specified. Then, from the registration information in the client-taste studying function unit 37, clients who have periodically purchased the commodities within the specified commodity list, and average purchase intervals are detected. This detection makes it possible to create a list of clients who have a possibility of purchasing a target commodity at the above-described time and date (or the time-period).

A third usage is the following retrieval. A specific commodity is specified, and service subscribers to which the advertisement of the commodity should be sent are listed up through the retrieval. With respect to this commodity and the advertisement publishing time and date, from the following information, the service subscribers who have a high-possibility of purchasing the commodity are classified into groups and listed up. The purchase achievement in the past on each service-subscriber basis, the purchase achievement on each client-group basis, advertisement requesting information registered beforehand by the service subscribers, or the like.

The selection processing of the advertisement-delivering method in (2) is a processing of selecting the advertisement-delivering method on the basis of the above-described retrieval processings' results. The advertisement-delivering method includes two instructing methods, i.e., an advertisement-publishing method and a selection of the advertisement-delivered destinations. The publication of the advertisement charges the subscribing shop dealer 40 an advertisement fee, and the charged fee differs depending on the advertisement-publishing method.

The advertisement-publishing method includes two types, i.e., first, the publication onto the advertisement list 302 in FIG. 20, and second, the publication onto the commodity list of each shop. In the first publication, the advertisement fee is charged which is generally high and which is proportional to the number of the advertisement-delivered destinations. Concerning the selection of the advertisement-delivered destinations, in the second publication, the advertisement is delivered to all of the service subscribers. Meanwhile, in the case of the first publication, the advertisement-delivered destinations are selectable. In this case, although it is possible to select all of the service subscribers, the delivery can also be performed only to specified service subscribers. In order to enhance the advertising effect, the delivery can be performed only to the above-described retrieved service subscribers who have the high-possibility of purchasing.

The creation and the delivery processings of the advertisement picture in (3) are as follows. With respect to the advertisement-published locations and the advertisement-delivered destinations determined by the above-described selection processing of the advertisement-delivering method, the advertisement creation processing units 113 automatically create the advertisement picture information for each service subscriber. Moreover, the units 113 directly send the information to the terminal apparatuses of the service subscribers via the networks, or distribute the information in a state of being stored into an electronic storage medium such as a CD-ROM or a memory card.

In addition to the above-described functions, the above-described advertisement creation processing unit 113 has the following functions further.

First, concerning an advertisement publication, the advertisement fee charged to a subscribing shop dealer that had published the advertisement is made changeable with respect to an order achievement that results from having selected the advertisement. For example, the fee is lowered, thereby encouraging the subscribing shop dealer to provide a commodity that is attractive to the service subscriber. Otherwise, the basic fee is lowered and the fee is set to be high at the time of only the order achievement, thereby making the advertisement easy to publish.

Second, a privilege corresponding to the service utilization (i.e., order of commodity) number or the utilization frequency is made available to the service subscriber. For example, in correspondence with the used money-amount within a fixed time-period (e.g., one month), the points are cumulated. Then, on a fixed time-period (e.g., a half year) basis, the points are converted into the corresponding money-amount so as to allowing the service subscriber to use the points at the time of the service utilization. Otherwise, regarding a service user who has a high utilization frequency within a fixed time-period, the money-amount equivalent to a fixed rate of the order amount is cumulated, thereby, in another fixed time-period, permitting the service user to enjoy the free-of-charge service utilization in the range of the cumulated amount.

Third, order information or retrieval information to a certain subscribing shop dealer is made to be undisclosed to another subscribing shop dealer. In that case, the advertisement fee is set which is higher than that of the disclosed case.

Fourth, the ASP providing dealer 39 performs a substitution service for the advertisement creation processing. In this service, the subscribing shop dealer beforehand specifies a list of commodities to be sold in a certain time-period and the sum total of the advertising expenses. In the specified range, the ASP providing dealer 39 selects commodities to be advertised and advertisement-sent destinations, then sending the advertisements. In this case, a fee is charged for the service, and also the charging system is selectable between a one-time-fixed-amount advertisement fee system and an advertisement fee system in correspondence with the order achievement. Also, as a part of this service, there is included a service where, instead of performing the advertisement delivery, information on the selection of a commodity and the group classification of the commodity-delivered destinations is delivered to the subscribing shop dealer.

The above-described order processing and advertisement creation processing allow a marketing service to be provided to a small-scale retail shop that cannot afford to make a commodity-marketing information processing investment.

The configuration of the client-taste studying function unit 37 explained so far makes it possible to provide the fine-grained service on each subscriber basis.

<<Transaction Form>>

The explanation will be given below concerning a concrete transaction form or service providing technique using the above-described electronic order-taking service system.

FIG. 21 illustrates one embodiment of the transaction form using the electronic order-taking service system. In this embodiment, the system configuration of the service subscribers 38, the ASP providing dealer 39, the subscribing shop dealers 40, and home-delivery dealers 41 provides the local-community closely-contacted type electronic order-taking service. The service subscribers 38 have the terminal apparatuses 1, respectively. The ASP providing dealer 39 has the ASP 7 as the host apparatus. The subscribing shop dealers 40 have the fulfillment side terminal apparatuses 40A, respectively.

Each service subscriber 38 performs the registration of the service provision with the ASP providing dealer 39, then giving an order for a commodity at each terminal apparatus.

Meanwhile, the ASP providing dealer 39 receives, from each joined subscribing shop dealer 40, catalogue information such as the advertisement of commodities that the dealer 40 wishes to provide in the ASP service. Also, the dealer 39 places the order from each service subscriber 38 to the subscribing shop dealer 40.

Also, each home-delivery dealer 41 receives the commodity from the subscribing shop dealer 40, then delivering the commodity to the service subscriber 38.

In the net-order sale service, in general, the response waiting time is long between each service subscriber and the ASP providing dealer. This becomes a bottleneck that damages the convenience. In particular, when providing a commodity sample as an image, it takes at fastest several seconds or, depending on the situation, tens of seconds until the sample image has appeared on the terminal apparatus of the service subscriber. This has become a factor that damages the convenience exceedingly.

Thus, in the transaction in FIG. 21, a catalogue information distribution/transmission such as a Virtual Web function or a catalogue distributing function is employed, thereby implementing the shortening of the above-described response waiting time.

In the method referred to as “Virtual Web function”, a prediction distribution/transmission and a registration distribution/transmission are included. The prediction distribution/transmission is as follows. The ASP providing dealer recognizes an application service that the service subscriber uses with a high utilization frequency, and predicts data or the like regarding this application service, then distributing/transmitting in advance the data or the like into the database in the terminal apparatus of the service subscriber. Also, the registration distribution/transmission is as follows. The service subscriber registers in advance the application service by the terminal apparatus, and the ASP providing dealer distributes/transmits in advance this in-advance registered data or the like into the database in the terminal apparatus of the service subscriber.

In the method referred to as “catalogue distributing function”, a prediction distribution and a registration distribution are included. The prediction distribution is as follows. The ASP providing dealer recognizes the application service that the service subscriber uses with a high utilization frequency, and commissions the home-delivery dealer to distribute catalogue data or the like (i.e., reproducible-function-limited information recorded in a CD-ROM, a memory card, or the like) regarding this application service. The service subscriber reproduces the catalogue data or the like in the contents-accumulating unit in the terminal apparatus, then accumulating the catalogue data or the like into the database. Also, the registration distribution is as follows. The service subscriber, by the terminal apparatus, registers an application service scheduled to be used, and the ASP providing dealer commissions the home-delivery dealer to distribute catalogue data or the like (i.e., reproducible-function-limited information recorded in a CD-ROM, a memory card, or the like) regarding this application service. The service subscriber reproduces the catalogue data or the like in the contents-accumulating unit in the terminal apparatus, then accumulating the catalogue data or the like into the database.

Based on the above-described catalogue information distribution/transmission, in particular, a sample image or the like which necessitates the long transmission time is distributed/transmitted in advance into the database on the terminal apparatus side. This distribution/transmission makes it possible to construct a high-convenience system where the response waiting time has been remarkably improved.

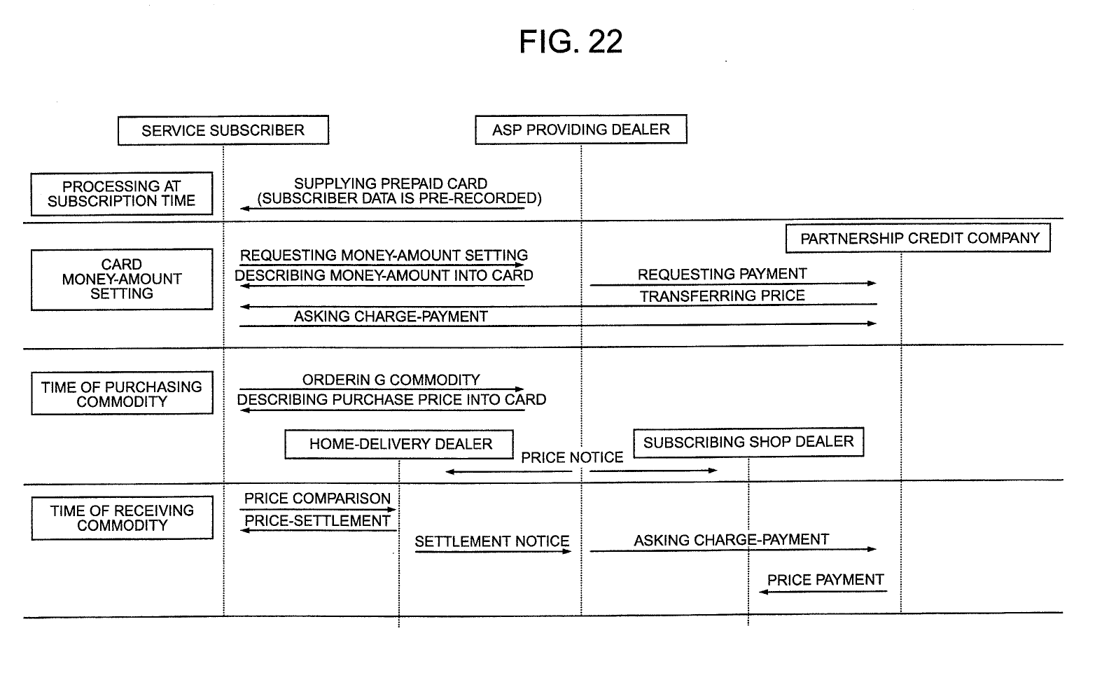

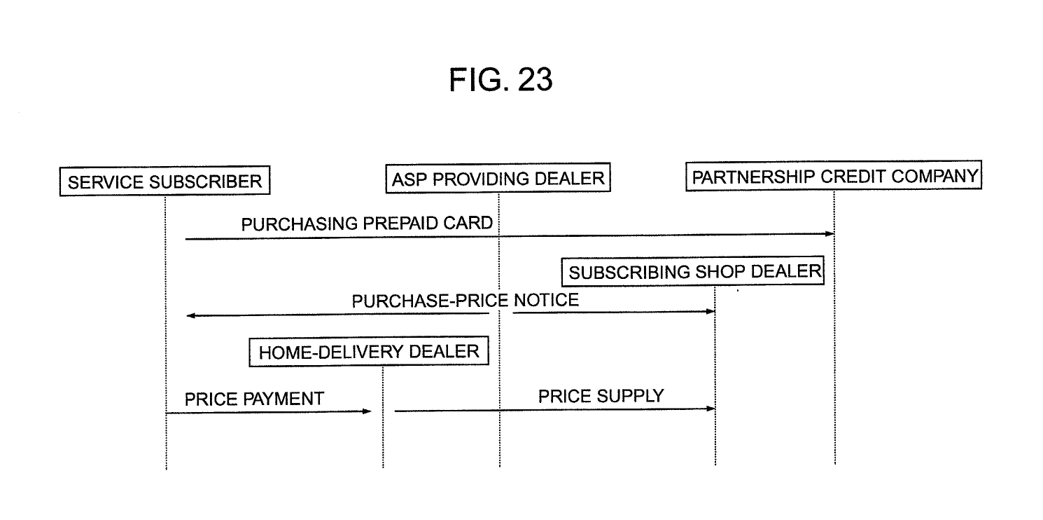

FIGS. 22 and 23 illustrate settlement techniques in the transaction using the above-described electronic order-taking service system. In the net-order sale service, in many cases, the price-settlement processing based on electronic money is employed. The service subscriber, however, feels a sense of uneasiness that the important information such as the ID number may be stolen in this process. Thus, as settlement methods that are preferable for eliminating this sense of uneasiness, it is advisable to employ the methods in FIGS. 22 and 23.

FIG. 22 illustrates the first settlement method. At the time of subscribing the service, from the ASP providing dealer, the service subscriber is supplied with a prepaid card where the subscriber data has been recorded.

In the case of using this card, at first, the service subscriber makes, to the ASP providing dealer, a setting request for setting a card money-amount. The ASP providing dealer requests a credit company in partnership therewith to make the payment-charging, and describes the money-amount into the card. Moreover, the partnership credit company makes the payment-charging to the service subscriber, and the service subscriber transfers the price into the account of the credit company. Through this process, the function as the prepaid card has been implemented.

At the time of purchasing a commodity, the service subscriber gives an order for the commodity, and the ASP providing dealer describes the purchase price into the prepaid card. In parallel to this, the ASP providing dealer sends a notice of the purchase price to the subscribing shop dealer and the home-delivery dealer.

At the time of receiving the commodity, the service subscriber makes a price comparison between the amount of a price charged by the home-delivery dealer and the money-amount described into the card. If both of the amounts coincide with each other, the service subscriber makes the settlement of the price by the prepaid card. Furthermore, the home-delivery dealer sends the settlement notice to the subscribing shop dealer. The subscribing shop dealer that has received this settlement notice makes the payment-charging to the partnership credit company, thereby receiving the payment of the price therefrom.

As explained above, according to this method, there exists almost none of the possibility that the important information on the subscriber may be stolen in the price-settlement processing. Also, even if the subscriber were to lose the prepaid card, the damage is limited only to the loss of the money-amount left in the prepaid card. Consequently, it becomes possible to implement a settlement processing with a sense of safety and a high-reliability.

FIG. 23 illustrates the second settlement method. This method is made simpler as compared with the settlement method in FIG. 22. At first, the service subscriber purchases the prepaid card from the partnership credit company. In addition, at the time of purchasing a commodity, the ASP providing dealer sends a notice of the purchase price to the service subscriber and the subscribing shop dealer.

At the time of receiving the commodity, the service subscriber pays the price to the home-delivery dealer by the prepaid card. Furthermore, the home-delivery dealer supplies this price to the subscribing shop dealer.

As explained above, according to this method as well, it becomes possible to implement the high-safety and high-reliability settlement processing toward the service subscriber.

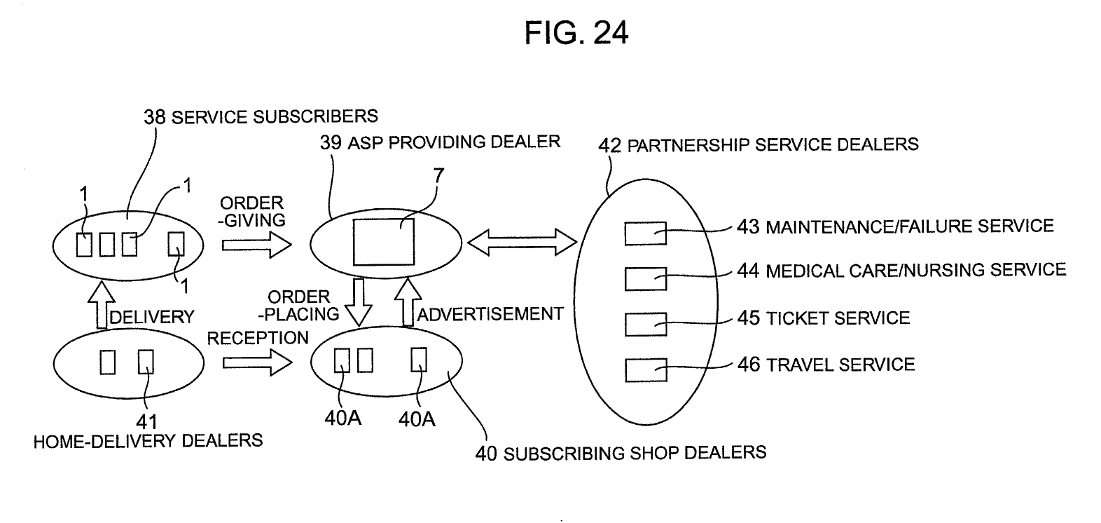

FIG. 24 illustrates a second embodiment of the service providing form using the above-described electronic order-taking service system. In the service providing form illustrated in FIG. 24, in addition to the electronic order-taking service, services provided by partnership service dealers 42 that implement the functions of the failure automatic reporting system, the life-reaction reporting system, and the like are added to FIG. 21.

Service subscribers 38, an ASP providing dealer 39, subscribing shop dealers 40, and home-delivery dealers 41 are the same as those in the first embodiment illustrated in FIG. 21. The partnership service dealers 42 linked with the ASP providing dealer 39 are newly added to the above-described same subscribers and dealers. This partnership service dealers 42 are determined depending on their implementing functions. In this embodiment, the dealers 42 include dealers of the following services. A maintenance/failure service 43 corresponding to the failure automatic reporting system, a medical care/nursing service 44 corresponding to the life-reaction reporting system, and a ticket service 45 and a travel service 46 which correspond to a hobby/leisure supporting system.

For example, if an abnormality of an Echonet-connected domestic electrical apparatus is detected by the terminal apparatus of the service subscriber, the abnormality is reported via the ASP providing dealer 39 to the maintenance/failure service 43. From here, a maintenance/repair service for the appliance is performed. Also, if an abnormality is detected in the life-reaction information by the terminal apparatus, the abnormality is reported via the ASP providing dealer 39 to the medical care/nursing service 44. From here, a service for confirming the safety of the subscriber is performed. Moreover, the subscriber selects a ticket service from among the service menus of the terminal apparatus, thus being capable of purchasing a wished ticket from the ticket service 45. Also, the subscriber selects a travel service in the service menus, thus being capable of receiving, from the travel service 46, services such as a travel guide or the reservation of a ticket or an accommodation facility.

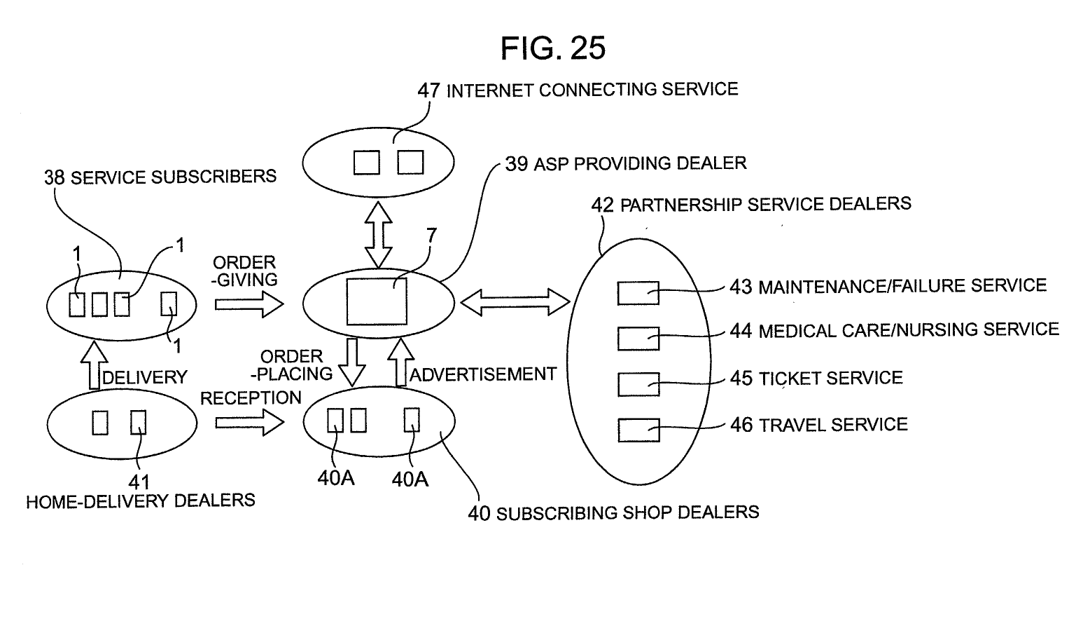

FIG. 25 illustrates a third embodiment of the service providing form using the above-described electronic order-taking service system. The embodiment in FIG. 25 results from adding an Internet connecting service to the embodiment in FIG. 24, thereby allowing the retrieval/collection of the various types of information to be performed using the Internet. In this embodiment, an Internet connecting service 47 linked with the ASP providing dealer 39 is newly added. Accordingly, using the Internet connecting service 47, the service subscriber can fetch necessary information or the like at the terminal apparatus.

Additionally, a variety of business-lines of dealers, such as a retail shop, a cooperative store, and a convenience store at the local-community, can participate as the subscribing shop dealers 40, although the detailed explanation thereof has been omitted in the embodiments in FIGS. 21, 24 and 25. Also, in addition to the form by the home-delivery, a purchased commodity can also be received in, e.g., a form of receiving the commodity at a near-by convenience store or the like.

As having been described so far, the service provision using the above-described electronic order-taking service system makes it possible to implement the provision of the local-community closely-contacted type outstanding-safety/convenience electronic order-taking service via the Echonet as the equipment-based home network. This implementation accomplishes exceedingly outstanding effects in the following. Making life activities of the service subscribers comfortable, activating the economy of the local-community including the local-community subscribing shop dealers, a life supporting system for the coming Aging Society, and the like.

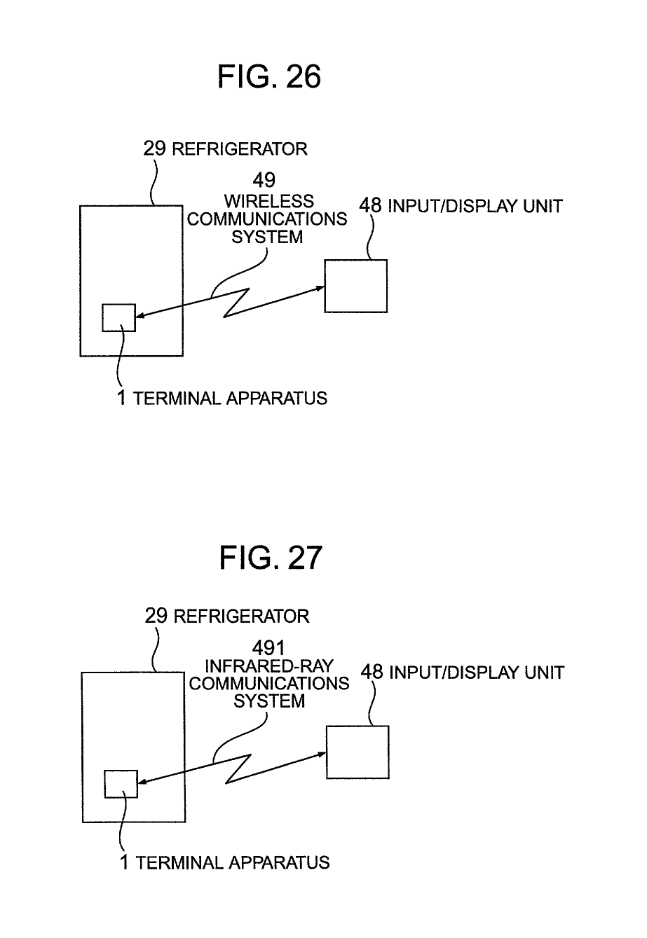

FIG. 26 illustrates another embodiment of the terminal apparatus. The terminal apparatus in the electronic order-taking service system is not limited to the above-described configuration of being fixedly located on a domestic electrical apparatus such as a refrigerator. Moreover, the input/display function of the terminal apparatus does not necessarily need to be implemented integrally with the refrigerator. In FIG. 26, a terminal apparatus 1 in the drawing, which is implemented in the refrigerator 29, includes units such as the controller and the ASP processing unit from which the input/display function has been removed. Meanwhile, an input/display unit 48 equipped with the input/display function performs the data transmission/reception with the terminal apparatus 1 via a wireless communications system 49 (e.g., Bluetooth or the like). Consequently, this input/display unit 48 can be cut off from the refrigerator 29, thereby permitting the electronic order-taking service or the like to be executed from an arbitrary location inside the home.

In a configuration in FIG. 27, the terminal apparatus 1 in the drawing, which is implemented in the refrigerator 29, includes the units such as the controller and the ASP processing unit from which the input/display function has been removed. Meanwhile, the input/display unit 48 equipped with the input/display function performs the data transmission/reception with the terminal apparatus 1 via an infrared-ray communications system 491 (e.g., IrDA or the like). Consequently, this input/display unit 48 can be cut off from the refrigerator 29, thereby permitting the electronic order-taking service or the like to be executed from an arbitrary location that the infrared-ray can reach.

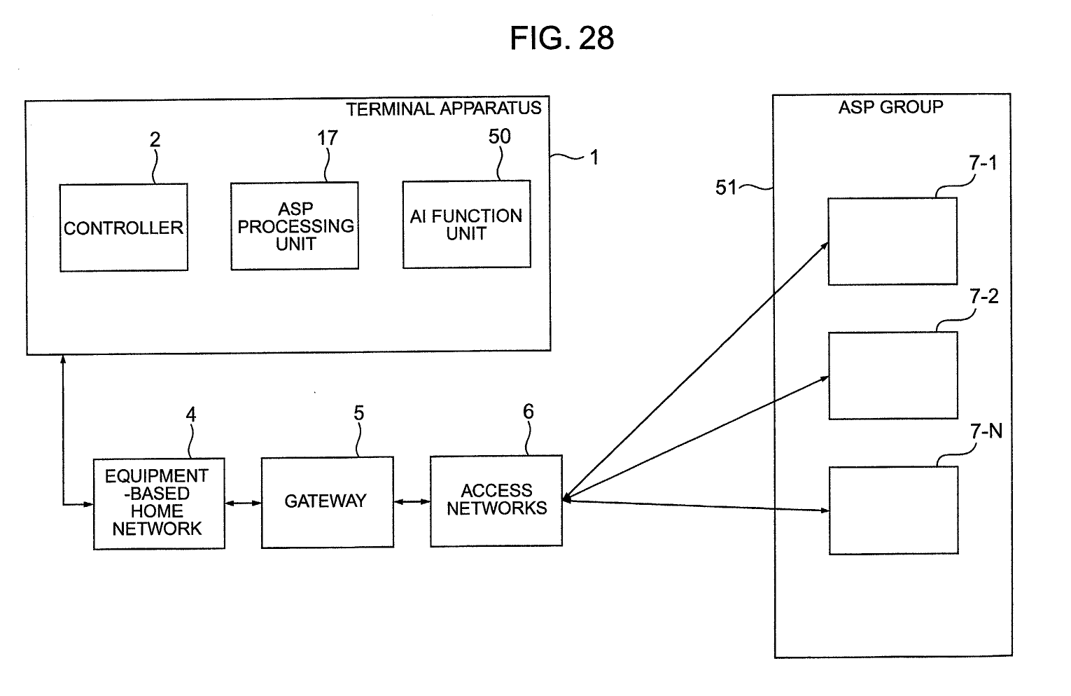

FIG. 28 illustrates still another embodiment of the terminal apparatus. An AI (i.e., Artificial Intelligence) function is added to the terminal apparatus 1, thereby implementing high-quality services based on selection judgements on high-level information. In the embodiment in FIG. 28, the terminal apparatus 1 includes the earlier-described controller 2 and ASP processing unit 17 and a newly added AI function unit 50. Also, an ASP group 51 means a plurality of service providing dealers ASPs 7-1, 7-2, . . . , 7-N, and performs the data transmission/reception with the terminal apparatus 1 via the equipment-based home network 4, the gateway 5, and the access networks 6 .

The AI function unit 50 has a first function, i.e., a function of judging an excellent-service-providing service providing dealer from among the plurality of service providing dealers so as to select the excellent-service-providing dealer with a high-priority, and a second function, i.e., a function of judging and precluding a high-pressure selling from the service providing dealers.

In the first function by the AI function unit 50, the AI function unit 50 performs an overall investigation of the prices and the qualities of same-kind commodities on the basis of the catalogue data or the like from the service providing dealers accumulated in the database or the contents-accumulating unit of the terminal apparatus, thereby listing up and memorizing an excellent-service-providing dealer on each commodity basis in the electronic order-taking service. Furthermore, if the service subscriber specifies a commodity that the subscriber wishes to purchase, the unit 50 automatically selects the ASP of the listed-up excellent-service-providing dealer so as to establish the connection with the dealer.

In the second function by the AI function unit 50, the AI function unit 50 accumulates a purchase taste of the service subscriber so as to automatically abandon the commodity service information from a service providing dealer which is not to the purchase taste, thereby precluding a high-pressure selling of the commodity from the service providing dealer.

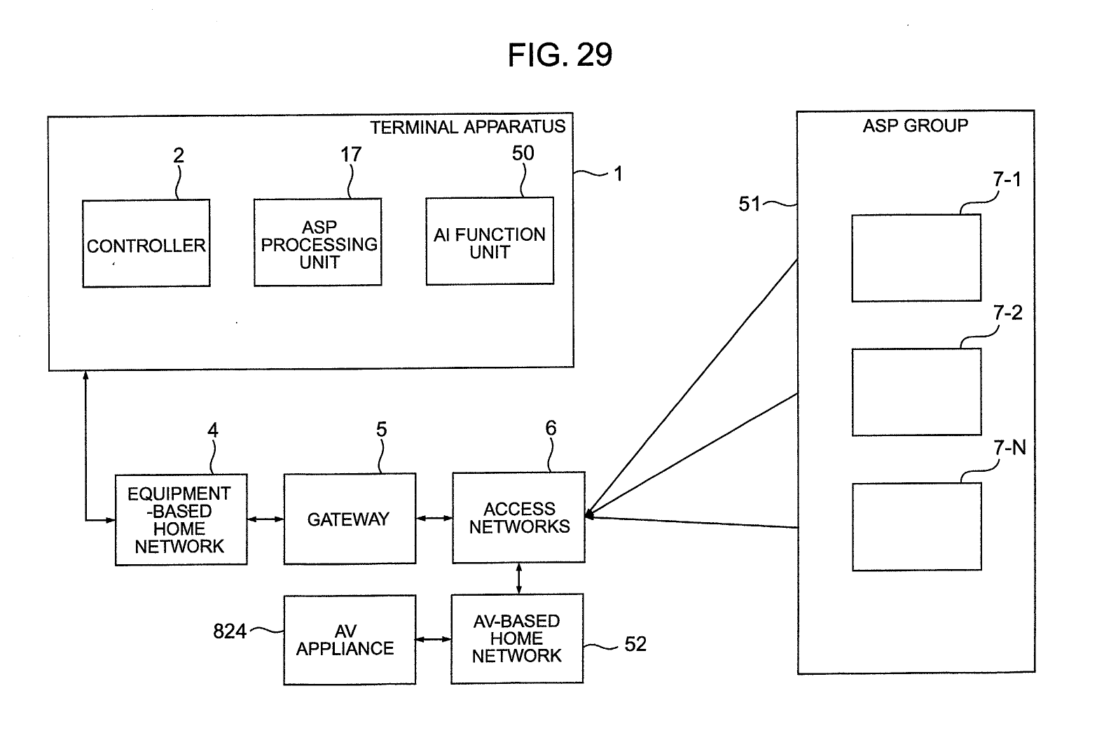

FIG. 29 illustrates a system embodiment that is connected to an AV-based home network as well. As the home network, i.e., the intra-home communications infrastructure, in addition to the Echonet as the equipment-based home network described so far, there exists the AV-based home network the target of which is an AV appliance system. In FIG. 29, information from the AV-based home network is also accumulated, thus performing the transaction with the service providing dealers more advantageously.

The information (e.g., data broadcasting service) obtained by an AV appliance 824 is supplied to the terminal apparatus 1 via the AV-based home network 52 and the gateway 5. In addition, the AI function unit 50 selects, out of the information, commodity information or the like which is effective in the electronic order-taking service, and accumulates the commodity information or the like into the database or the contents-accumulating unit.

In the electronic order-taking service, out of the accumulated commodity information or the like, information that makes the transaction advantageous is provided to the service providing dealer in correspondence with the private rank. Moreover, in correspondence with the value of the provided information, the service providing dealer sets the commodity discount rate or the like. This further accomplishes outstanding effects in an enhancement in the service subscriber's convenience, an enhancement in the provided service quality, and the like.

Based on the above-described embodiments, the concrete explanation has been given so far concerning the invention devised by the present inventor. It is needless to say, however, that the present invention is not limited thereto and is amendable in a variety of ways within the scope of not departing the essence thereof.

The Echonet the development and standardization of which Echonet Consortium of Japan is now promoting has been employed as one embodiment of the equipment-based home network. It is apparent, however, that the present invention is also applicable to the equipment-based home network according to the home networking technology the development and standardization of which HomePlug Powerline Alliance of the United States is now promoting.

Also, it is needless to say that, in addition to the public line such as the telephone line, a wireless access network, the power line, or the like is also usable as the access networks in the present invention.

Explaining briefly effects obtained by the representative invention of the inventions disclosed in the present application, the effects are as follows.

It becomes possible to facilitate the setting and the management of the cryptographic key needed when the domestic electrical apparatus or the like is made applicable to the terminal apparatus of the net-order sale or the like.

It becomes possible to enhance the safety and the convenience in the electronic transaction when the domestic electrical apparatus or the like is made applicable to the terminal apparatus of the net-order sale or the like.

It becomes possible to allow, using the domestic electrical apparatus or the like, the implementation of the high added-value of being able to be closely linked and associated with a social system through the connection to a wide area network or the like.

By focusing attention on the characteristics of the equipment-based home network, e.g., no wiring required, the simple application development, the plug-and-play function, and the wide-area-network connection, it becomes possible to implement the service system (i.e., the electronic order-taking service system) that can be positioned as the electronic order-taker for implementing the local-community closely-contacted type outstanding-convenience/safety net-order sale or the like.

Based on the above-presented description, it becomes possible to accomplish the exceedingly outstanding effects in the following. Making life activities of the service subscribers comfortable, activating the economy of the local-community including the local-community subscribing shop dealers, a life supporting system for the coming Aging Society, and the like.

It will be further understood by those skilled in the art that the foregoing description has been made on embodiments of the invention and that various changes and modifications may be made in the invention without departing from the spirit and scope the appended claims.

What is claimed is:

1. A domestic electrical apparatus, comprising:
a controller unit including communication means with an outside, operating means, and data processing means,
wherein said controller unit further includes a cryptographic processing unit for utilizing information as a part or a whole of a cryptographic key for an information communication performed by said communication means, said information having a one-to-one correspondence relationship with an appliance number that is specific to said domestic electrical apparatus.

2. A domestic electrical apparatus as claimed in claim 1, wherein, when said appliance number is utilized as said part of said cryptographic key, remainder of said cryptographic key is information that has a one-to-one correspondence relationship with code information for specifying a manufacturing maker of said domestic electrical apparatus.

3. A domestic electrical apparatus as claimed in claim 1, wherein said cryptographic processing unit converts information data to be sent, into encrypted data by using said cryptographic key, and decrypts received data back to information data by using said cryptographic key.

4. A domestic electrical apparatus as claimed in claim 3, wherein
said communication means is connectable to an Echonet implemented for a power line carrier communication; and
said data processing means is controllable to service providing parties on a wide area network from said Echonet via a gateway.

5. A domestic electrical apparatus as claimed in claim 3, wherein said data processing means is controllable to send provision of a service along with a user ID to service providing parties on a wide area network via said communication means, said service being specified by an operation performed by said operating means.

6. A domestic electrical apparatus as claimed in claim 4, wherein said controller unit includes an authenticating unit for executing an authentication of an operating party for said operating means.

7. A domestic electrical apparatus as claimed in claim 4, wherein said controller unit stores information for supporting said operation performed by said operating means for requesting said service provision, and further includes a database made accessible from said data processing means.

8. A domestic electrical apparatus as claimed in claim 4, wherein said data processing means has a controlling function for selecting a superior service providing party by considering a price-to-service ratio with respect to said service specified from said operating means.

9. A domestic electrical apparatus as claimed in claim 4, wherein said controller unit further includes a life-reaction processing unit for detecting presence or absence of a life-reaction on a basis of an interval between operations toward said domestic electrical apparatus to be capable of making an abnormality report via said communication means on a basis of a judgement that there exists no life-reaction.

10. A domestic electrical apparatus as claimed in claim 4, wherein said controller unit further includes a failure detection processing unit that is capable of making a failure report via said communication means when said domestic electrical apparatus is judged to fail.

11. A domestic electrical apparatus as claimed in claim 3, wherein said controller unit further includes an energy-saving processing unit for controlling said domestic electrical apparatus into a working state that is suitable for a set-up environment of said domestic electrical apparatus.

12. A domestic electrical apparatus as claimed in claim 3, wherein said operating means performs said transmission/reception of said information with said data processing means via a power-saved wireless or infrared ray.

13. A subscriber registering method of registering, as a service requester, a purchaser of a domestic electrical apparatus into a computer apparatus of a service provider for providing a predetermined service to said purchaser, comprising the processings of:
inputting an appliance number specific to said domestic electrical apparatus that said purchaser purchases;
acquiring a cryptographic key having a one-to-one correspondence relationship with said inputted appliance number; and
registering said acquired cryptographic key as one of subscriber information on said service requester,
wherein, in performing service provision to said subscriber, information to be provided to said subscriber is encrypted using said cryptographic key, and information provided from said subscriber is decrypted using said cryptographic key.

14. A subscriber registering method as claimed in claim 13, wherein said processing of acquiring said cryptographic key includes a processing of presenting said appliance number to a computer apparatus that a manufacturing maker of said domestic electrical apparatus manages, and a processing of receiving said cryptographic key returned in response to said presented appliance number.

15. An order receiving method by which a host apparatus connected to a terminal apparatus via a network receives an order from said terminal apparatus, comprising the processings of:
making reference to a database in which cryptographic keys are registered in being caused to correspond to user IDs, said cryptographic keys being caused to be related in a one-to-one manner to appliance numbers specific to domestic electrical apparatuses onto which terminal apparatuses are integrated, to retrieve a cryptographic key corresponding to a user ID from said terminal apparatus;
decrypting, using said retrieved cryptographic key, order data from said terminal apparatus to receive said order; and
encrypting, using said retrieved cryptographic key, confirmation data for confirming said received order.

16. An order receiving method as claimed in claim 15, further comprising a processing of setting an upper-limit of a price for said order from said terminal apparatus to limit reception of said order up to said upper-limit.

17. An order receiving method as claimed in claim 15, wherein said host apparatus performs a processing of sending order-reception information to a dealing party for performing dispatch of an order-received commodity or fulfillment of an order-received service.

18. An order receiving method as claimed in claim 15, wherein said host apparatus performs a processing of sending order-reception information to a settlement institution for settling a price for a received order.

19. An order receiving method as claimed in claim 15, wherein said host apparatus performs a processing of providing in advance order-receivable contents to a plurality of terminal apparatuses as a transaction guide.

20. An order receiving method as claimed in claim 15, wherein said host apparatus performs a processing of studying order-received contents on each user ID basis, and of providing order-receivable transaction contents, which satisfy a taste predicted from result of said study, to said terminal apparatus of said user ID as a transaction guide.

21. A data processing system comprising a host apparatus connectable to a terminal apparatus via a network, wherein
said host apparatus includes a database in which cryptographic keys are registered in being caused to correspond to user IDs, said cryptographic keys being caused to be related in a one-to-one manner to appliance numbers specific to domestic electrical apparatuses onto which terminal apparatuses are integrated,
said host apparatus retrieves, from said database, a cryptographic key corresponding to a user ID that accompanies a transaction request from said terminal apparatus, and
said host apparatus decrypts, using said retrieved cryptographic key, information data sent from said terminal apparatus, and encrypts, using said retrieved cryptographic key, information data to be sent to said terminal apparatus, thereby receiving said transaction request from said terminal apparatus.

22. A data processing system as claimed in claim 21, further comprising a fulfillment side terminal apparatus for inputting transaction request contents to cause said contents to be fulfilled, said transaction request contents being received from said terminal apparatus by said host apparatus.

23. A data processing system as claimed in claim 21, further comprising a price-settlement side terminal apparatus for inputting transaction request contents to cause a price for said request to be settled, said transaction request contents being received from said terminal apparatus by said host apparatus.
